(19) United States
(12) Patent Application Publication
(10) Pub. No.: US 2024/0087091 A1
(43) Pub. Date: Mar. 14, 2024

(54) SERVER DEVICE AND NETWORK CONTROL METHOD

(71) Applicant: Sony Group Corporation, Tokyo (JP)

(72) Inventors: Yasuaki YAMAGISHI, Tokyo (JP); Hiroshi KUNO, Tokyo (JP); Kazuhiko TAKABAYASHI, Tokyo (JP)

(73) Assignee: Sony Group Corporation, Tokyo (JP)

(21) Appl. No.: 18/270,864

(22) PCT Filed: Mar. 15, 2021
(86) PCT No.: PCT/JP2021/010296

§ 371 Date: Jul. 5, 2023

Related U.S. Application Data
(60) Provisional application No. 63/136,261, filed on Jan. 12, 2021.

(51) Int. Cl. G06T 5/10; G06T 15/20

(52) U.S. Cl. CPC G06T 5/10; G06T 15/205

(57) ABSTRACT

The present disclosure relates to a server device and a network control method that are configured to reduce traffic of object data constituting a virtual space. A live entertainment broker filters each of first object data that is object data of a first object and second object data that is object data of a second object based on a determined filtering condition, the first object and the second object being to be displayed in a virtual space, and sends the filtered object data to a rendering server. This technology can be applied, for example, to a data processing system that provides a live entertainment service that provides live performances of artists in real time.

### TECHNICAL FIELD

The present disclosure relates to a server device and a network control method, and more particularly to a server device and a network control method that are configured to reduce traffic of object data constituting a virtual space.

### BACKGROUND ART

Extended Reality (XR) is being considered for application in various application domains such as entertainment, healthcare, and education. For example, it is being considered an entertainment service in which a virtual space is constructed in which a user who sits in a stadium in the virtual space watches a game while talking with another user who sits next to the user in the stadium but is in a different place in the real space (for example, see NPL 1).

It may also be considered, for example, amongst entertainment services, a live entertainment service in which a live space including artists and audiences is constructed as a virtual space.

### CITATION LIST

### Non Patent Literature

[NPL 1]
3GPP TR 26.928, “6.2.3 Viewport-dependent Streaming”, “A.22 Use Case 21: Immersive 6DoF Streaming with Social Interaction”

### SUMMARY

### Technical Problem

In constructing the virtual space for the above-mentioned live entertainment service, assuming one server instance is allocated to several audiences, for example, for about 1 million audiences, a huge number of server instances corresponding to the audiences will be required. This would further require the sending of all the live action-based video data of artists and audiences to each instance, resulting in a drastically increased traffic between the instances, which potentially breaks the system.

The present disclosure has been made in view of such circumstances, and is intended to reduce the traffic of object data constituting a virtual space.

### Solution to Problem

A server device according to one aspect of the present technology includes a broker that filters each of first object data that is object data of a first object and second object data that is object data of a second object based on a determined filter condition, the first object and the second object being to be displayed in a virtual space, and sends the filtered object data to a rendering server.

A network control method according to one aspect of the present technology includes: by a server device, filtering each of first object data that is object data of a first object and second object data that is object data of a second object based on a determined filtering condition, the first object and the second object being to be displayed in a virtual space; and sending the filtered object data to a rendering server.

In one aspect of the present technology, first object data that is object data of a first object and second object data that is object data of a second object are filtered based on a determined filtering condition, the first object and the second object being to be displayed in a virtual space, and the filtered object data is sent to a rendering server.

The server device according to one aspect of the present technology can be realized by causing a computer to execute a program. The program to be executed by the computer can be provided by being sent via a transmission medium or by being recorded on a recording medium.

The server device may be an independent device or an internal block constituting one device.

### BRIEF DESCRIPTION OF DRAWINGS

FIG. 1 is a diagram illustrating a live entertainment service provided by a data processing system to which the technology according to the present disclosure is applied.

FIG. 2 is a block diagram of the data processing system for providing the live entertainment service of FIG. 1.

FIG. 3 is a flowchart illustrating object data generation processing.

FIG. 4 is a block diagram illustrating a configuration of the data processing system.

FIG. 5 is a diagram illustrating the operation of the data processing system.

FIG. 6 is a diagram illustrating an object data subscription.

FIG. 7 is a flowchart illustrating processing prior to object data being published.

FIG. 8 is a diagram illustrating an example of an object data publication structure.

FIG. 9 is a flowchart illustrating object data forward processing immediately before rendering.

FIG. 10 is a diagram illustrating rendering processing.

FIG. 11 is a flowchart illustrating rendering processing for dynamically changing the place where a renderer runs.

FIG. 12 is a diagram illustrating rendering data aggregation processing.

FIG. 13 is a diagram illustrating a display image example in the rendering data aggregation processing.

FIG. 14 is a flowchart illustrating rendering processing when the rendering data aggregation processing is performed.

FIG. 15 is a diagram illustrating the rendering data aggregation processing performed depending on data type.

FIG. 16 is a diagram illustrating the rendering data aggregation processing performed depending on data type.

FIG. 17 is a diagram illustrating a local live entertainment broker.

FIG. 18 is a flowchart illustrating object data forward processing using the local live entertainment broker.

FIG. 19 is a diagram illustrating variations of filter conditions.

FIG. 20 is a diagram illustrating an example of filter data.

FIG. 21 is a diagram conceptually illustrating filtering processing using the formula of FIG. 20.

FIG. 22 is a diagram illustrating a subdivision setting example of weighting parameters.

FIG. 23 is a diagram illustrating examples of weighting parameters of filter data and a weighting parameter formula.

FIG. 24 is a diagram conceptually illustrating filtering processing using the formula of FIG. 23.

FIG. 25 is a diagram illustrating differences in display in the filtering processing.

FIG. 26 is a diagram illustrating the filtering processing of the local live entertainment broker.

FIG. 27 is a diagram illustrating an example of filter data.

FIG. 28 is a block diagram illustrating a functional configuration example of a client device.

FIG. 29 is a block diagram illustrating a functional configuration of a server side renderer.

FIG. 30 is a block diagram illustrating a functional configuration of an object data server.

FIG. 31 is a block diagram illustrating a functional configuration of an object data publisher.

FIG. 32 is a block diagram illustrating a functional configuration of an object data subscriber.

FIG. 33 is a block diagram illustrating a functional configuration of an edge resource orchestrator.

FIG. 34 is a block diagram illustrating a functional configuration of a live entertainment broker.

FIG. 35 is a block diagram illustrating a configuration example of cloud computing to which the present technology is applied.

### DESCRIPTION OF EMBODIMENTS

Modes for embodying the present disclosure (hereinafter referred to as embodiments) will be described below with reference to the accompanying drawings. The term “and/or” as used herein means either “and” or “or”. In the present specification and the drawings, components having substantially the same functional configuration will be denoted by the same reference numerals, and thus repeated descriptions thereof will be omitted. Description will be given in the following order.
1. Overview of Live Entertainment Service
2. Configuration Example of Data Processing System
3. Object Data Publication
4. Object Data Forward Processing Before Rendering
5. Explanation of Rendering Processing
6. Rendering Data Aggregation Processing
7. Rendering Data Aggregation Processing Depending on Data Type
8. Combination of Rendering Data Aggregation Processing and Client Side Renderer
9. Local Live Entertainment Broker
10. Variations of Filter Condition
11. Example of Filtering
12. Subdivision Setting Example of Weighting Parameters
13. Filtering Processing of Local Live Entertainment Broker
14. Block Diagram of Functional Components
15. Configuration Example of Cloud Computing

### <1. Overview of Live Entertainment Service>

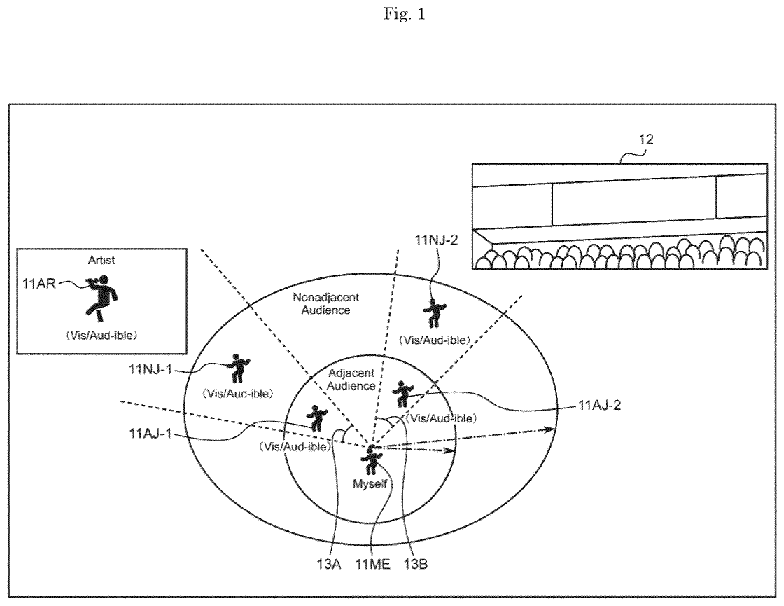

First, with reference to FIG. 1, a live entertainment service will be described that is provided by a data processing system to which the technology according to the present disclosure is applied.

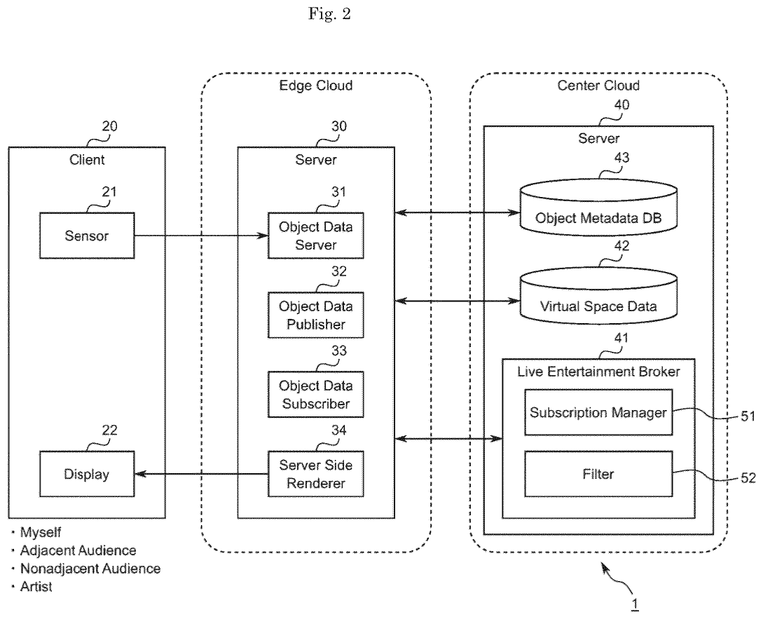

The data processing system 1, which will be described with reference to FIG. 2 and subsequent figures, is a system that constructs a concert venue including an artist(s) and audiences in a virtual space and provides a live entertainment service that provides live performances of the artist(s) in real time.

One artist and a lot of audiences, who are in different places in the real space (real world), participate in the live entertainment service provided by the data processing system 1. Each of the audiences is a live viewer. Of course, a plurality of artists may participate in it.

Now, assuming that one audience of interest is a viewer 11ME as illustrated in FIG. 1, other audiences may be classified into adjacent audiences 11AJ and nonadjacent audiences 11NJ in terms of the relationship with the viewer 11ME. The adjacent audiences 11AJ and the nonadjacent audiences 11NJ are classified based on, for example, the distances from the viewer 11ME (Myself) according to their seat positions in the concert venue in the virtual space, interests, the degrees of interest, and the like. The adjacent audiences 11AJ are different from the nonadjacent audiences 11NJ in level of detail (LOD) represented in the virtual space. When the adjacent audiences 11AJ are not particularly distinguished from the nonadjacent audiences 11NJ, they are simply referred to as the audiences 11AU.

The virtual space for the live entertainment service is constructed in which 3D objects (hereinafter, also simply referred to as objects) of the viewer 11ME, an artist 11AR, the adjacent audiences 11AJ, and the nonadjacent audiences 11NJ are placed in the virtual concert venue 12. For example, volumetric capture technology is used to place each 3D object of the viewer 11ME, the artist 11AR, the adjacent audiences 11AJ, and the nonadjacent audiences 11NJ in the virtual concert venue 12 so that the movement of the person in the real world is reflected in real time. The volumetric capture technology is a technology that generates a 3D object of a subject from moving images captured from multiple viewpoints and generates a virtual viewpoint image of the 3D object according to any viewing position. In the present embodiment, the method of generating and displaying the 3D object is not limited. For example, a technology that generates an object of a subject by using moving images captured in two different directions may be used.

The data of each object of the viewer 11ME, the artist 11AR, the adjacent audiences 11AJ, and the nonadjacent audiences 11NJ is composed of the momentary shape of that object in the virtual space, the position and movement in the virtual space, light (color), sound, smell, wind pressure, and hot air data, which are generated by that object (and observed from the outside of that object), and the like. However, in the present embodiment, visible and audible data will be focused on as the data of each object, for the sake of simple explanation. The visible data of each object is composed of video data such as mesh data, texture data, motion data, and the audible data is composed of audio data.

In the live entertainment service, for example, when the viewer 11ME is looking in a direction 13A to the artist 11AR, the object of the artist 11AR that is at the viewpoint or within the visible scope of the viewer 11ME and the objects of an adjacent audience 11AJ-1 and a nonadjacent audience 11NJ-1 in that direction 13A are displayed on a display of the viewer 11ME.

Also, for example, when the viewer 11ME changes the line of sight to look in a direction 13B different from the direction 13A to the artist 11AR, the objects of an adjacent audience 11AJ-2 and a nonadjacent audience 11NJ-2 that are at the viewpoint or within the visible scope in the direction 13B are displayed on the Display.

### <2. Configuration Example of Data Processing System>

FIG. 2 is the data processing system to which the present technology is applied, and is a block diagram illustrating components of the data processing system that provides the above-described live entertainment service.

The data processing system 1 includes client devices 20 for the viewer 11ME, the artist 11AR, the adjacent audiences 11AJ, and the nonadjacent audiences 11NJ. In other words, the client devices 20 are provided for the viewer 11ME, the artist 11AR, the adjacent audiences 11AJ, and the nonadjacent audiences 11NJ in one-to-one correspondence. Each client device 20 includes a sensor 21 and a display 22.

A server device 30 is provided on an edge cloud in correspondence to each client device 20. In the present embodiment, to simplify the explanation, it is assumed that the client device 20 and the server device 30 have a one-to-one relationship. However, the server device 30 and the client devices 20 may have a one-to-many relationship, that is, one server device 30 may manage a plurality of client devices 20. The server device 30 includes an object data server 31, an object data publisher 32, an object data subscriber 33, and a server side renderer 34.

The sensor 21 and the display 22 of the client device 20 do not need to be integrated into one device, and may be separate devices. Similarly, the object data server 31, the object data publisher 32, the object data subscriber 33, and the server side renderer 34 of the server device 30 may also be configured as two or more separate devices.

Furthermore, the data processing system 1 includes a server device 40 shared by the server devices 30 of the viewer 11ME, the artist 11AR, the adjacent audiences 11AJ, and the nonadjacent audiences 11NJ on a center cloud.

The server device 40 includes a live entertainment broker 41, a virtual space DB 42, and an object metadata DB 43; the live entertainment broker 41 includes a subscription manager 51 and a filter 52. The live entertainment broker 41, the virtual space DB 42, and the object metadata DB 43 may also be configured as two or more separated devices instead of being integrated into one device.

The edge cloud is an edge side cloud close to the client device 20. For example, for the network being a mobile phone communication network, the edge cloud s configured to include base stations and the like. The center cloud is a cloud such as a core network other than the edge cloud.

A cloud including the edge cloud and the center cloud is configured to include a plurality of nodes and a network connecting them. For example, the network is configured to include a network or communication path compliant with any communication protocol/standard, for example, the Internet, a public telephone network, a wide area communication network for wireless mobile such as what are known as 4G circuits and 5G circuits, a wide area network (WAN), a local area network (LAN), a wireless communication network for communication compliant with the Bluetooth (registered trademark) standard, a communication path for short-range communication such as near-field communication (NFC), a communication path for infrared communication, a communication network for wired communication compliant with standards such as High-Definition Multimedia Interface (HDMI)(registered trademark) or Universal Serial Bus (USB), or the like. Each node constituting the cloud is configured to include network connection devices such as sensor devices, routers, modems, hubs, bridges, switching hubs, base station control devices, exchanges, and server devices. A server device as a node and an application executed on that device implements functions, which will be described below, to serve as the object data server 31, the object data publisher 32, the object data subscriber 33, the server side renderer 34, the live entertainment broker 41, the virtual space DB 42, or the object metadata DB 43.

The sensor 21 is a device that acquires sensor data for generating the object of the corresponding one of the viewer 11ME, the artist 11AR, the adjacent audiences 11AJ, and the nonadjacent audiences 11NJ. The sensor 21 is configured to include, for example, an imaging sensor that generates an RGB image. The sensor 21 may be configured to include a plurality of sensor devices that are of the same type or different types, such as an imaging sensor and a distance measuring sensor. The sensor 21 sends the acquired sensor data to the object data server 31.

The display 22 receives rendering data sent from the server side renderer 34 in the edge cloud, and displays a live video of the object of the artist 11AR at the virtual concert venue 12. The live video displayed on the display 22 also includes the objects of the adjacent audiences 11AJ and the nonadjacent audiences 11NJ according to the viewpoint or visible scope of the viewer 11ME. The live video displayed on the display 22 is a 2D image of the objects, such as of the artist 11AR, the adjacent audiences 11AJ, and the nonadjacent audiences 11NJ, generated according to the viewpoint or visible scope of the viewer 11ME.

The object data server 31 generates object data from the sensor data sent from the sensor 21 of the client device 20. The generated object data is temporarily stored in an internal storage unit and then forwarded to the object data publisher 32 or the object data subscriber 33.

The object data server 31 can not only generate the object data at the present time based on the sensor data sequentially received from the sensor 21, but also generate object data based on near-future prediction (for example, future line-of-sight prediction by line-of-sight tracking).

The object data publisher 32 extracts information necessary for object rendering from the object data supplied from the object data server 31 and sends (forwards) the information to the live entertainment broker 41.

The object data subscriber 33 detects a change in viewpoint information of a subject (artist or audience) in the real world based on the object data supplied from the object data server 31. The viewpoint information includes a line-of-sight direction and a visual range.

The object data subscriber 33 negotiates with the subscription manager 51 of the live entertainment broker 41 for the display level of the object(s) at the viewpoint or within the visible scope, based on the detected viewpoint information of the subject. The display level of the object(s) is a level of detail to be displayed.

The object data subscriber 33 receives the object data at the viewpoint or within the visible scope from the filter 52 of the live entertainment broker 41 and supplies the object data to the server side renderer 34.

The server side renderer 34 generates rendering data based on the object data at the viewpoint or within the visible scope, which is supplied from the object data subscriber 33. The server side renderer 34 encodes the generated rendering data using a predetermined compression and encoding method, and sends the encoded stream data to the display 22 of the client device 20.

The data on each of the objects of the artist and the audiences can be recorded in any data format. The geometry information (shape information) of the object can be stored, for example, in the form of a set of points (point cloud) or in the form of a polygon mesh represented by vertices and connections between the vertices. The color information of an object can be stored in the form of a UV texture using a UV coordinate system, in the form of multi-texture in which a plurality of two-dimensional texture images are stored, or the like.

The rendering of an object is the processing of generating a 2D image (object image) of the object from the viewpoint of a virtual camera based on the 3D model data of the object. The 3D model of the object is perspectively projected to the viewpoint or visible scope of the viewer 11ME based on the viewpoint information detected by the object data subscriber 33 so as to generate the object image from the viewpoint of the viewer 11ME. For example, the advanced video coding (AVC) method, the high efficiency video coding (HEVC) method, or the like can be adopted as the compression and encoding method for the generated object image, which is a 2D image.

The subscription manager 51 of the live entertainment broker 41 negotiates with the object data subscriber 33 for the display level of the object(s). Specifically, a filter condition is determined for how to filter each of the objects such as the artist 11AR, the adjacent audiences 11AJ, and the nonadjacent audiences 11NJ, which are present at the viewpoint or within the visible scope of the viewer 11ME.

The filter 52 filters the object data of each of the objects, which are present at the viewpoint or within the visible scope of the viewer 11ME, based on the filter condition determined by the subscription manager 51. The filter 52 sends the filtered object data to the object data subscriber 33.

The virtual space DB 42 stores state information shared by the objects. The virtual space DB 42 stores, for example, seat information of the stadium or hall, which is the virtual concert venue 12, information on shape, material, temperature, and humidity of the space, and the like.

The object metadata DB 43 stores attribute information of each of the objects such as the artist 11AR, the adjacent audiences 11AJ, and the nonadjacent audiences 11NJ. The object metadata DB 43 stores query information for making reference to the attribute information of each object and query information for making reference to the state information stored in the virtual space DB 42.

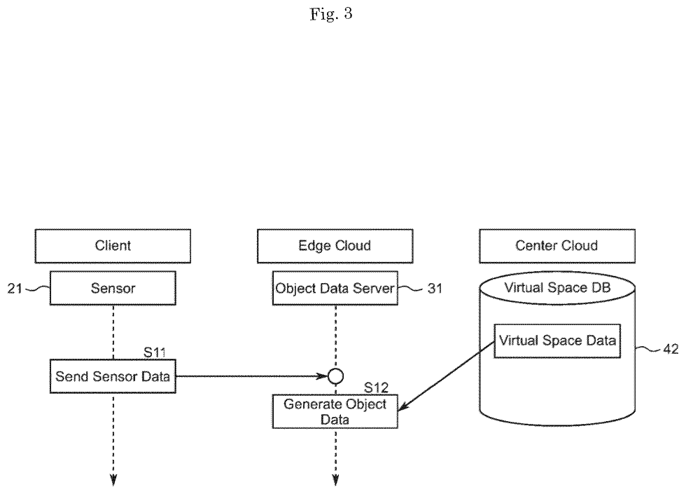

With reference to the flowchart of FIG. 3, object data generation processing will be described that is executed between the client device 20 and the server device 30 for each of the viewer 11ME, the artist 11AR, the adjacent audiences 11AJ, and the nonadjacent audiences 11NJ.

First, in step S11, the sensor 21 of the client device 20 acquires sensor data obtained by observing the target subject and sends the sensor data to the object data server 31 of the corresponding server device 30.

In step S12, the object data server 31 receives the sensor data sent from the sensor 21 and generates object data based on the sensor data. The generated object data is stored in an internal storage unit. The state information stored in the virtual space DB 42 in the center cloud is referred to in generating the object data. The state information stored in the virtual space DB 42 is, for example, the seat information of the stadium or hall, which is the virtual concert venue 12, and the information on the shape, material, temperature, humidity of the space, and the like.

The generated object data of each of the viewer 11ME, the artist 11AR, the adjacent audiences 11AJ, and the nonadjacent audiences 11NJ is composed of moving image video data and audio data. In addition to generating object data at the present time, it is possible to generate object data based on near-future prediction.

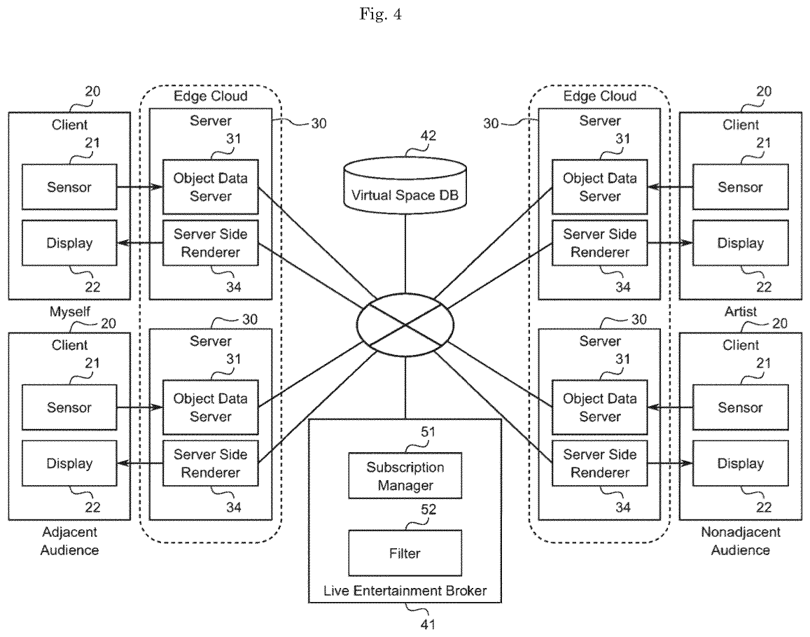

The client device 20 and the server device 30 are provided for each of the viewer 11ME, the artist 11AR, the adjacent audiences 11AJ, and the nonadjacent audiences 11NJ, as illustrated in FIG. 4. Note that FIG. 4 illustrates only the object data server 31 and the server side renderer 34 for each server device 30 due to the limited space for drawing.

All the devices included in the data processing system 1 support a real-time control environment, such as time-sensitive networking (TSN), so as to guarantee the synchronization of data exchanged between the devices. Specifically, the data processing system 1 can precisely measure the time when the sensor data is generated so that media can easily synchronize during playback, and control the reservation of resources for network/transport processing (classes such as transfer bandwidth, delay, and jitter) in real time.

The object data server 31 deployed on the edge cloud acquires sensor data generated by the sensors 21 of one or more client devices 20 under its control, generates object data, and sends the generated object data to other server devices 30. The server side renderer 34 collects object data necessary for rendering from other server devices 30, further adds shared state information such as data on the virtual concert venue 12 to the object data, and loads the resulting object data into the memory to render.

The live entertainment service is expected to have a large number of audiences, such as millions. A large number of client devices 20 corresponding to the viewer 11ME, the adjacent audiences 11AJ, and the nonadjacent audiences 11NJ can cause a huge amount of traffic and bring down the system.

The traffic related to the artist 11AR is indispensable and unavoidable while the traffic related to the audiences is preferably reduced if possible. Data filtering is preferably executed according to the distance between audiences in the virtual space, for example, “for adjacent audiences, their movements, facial expressions, and voices can be recognized while for distant audiences, only their loud voices and large movements can be recognized”.

Therefore, the data processing system 1 is provided with the live entertainment broker 41 having a traffic filtering function in order to alleviate excessive traffic.

Specifically, the server side renderer 34 for the client device 20 of the viewer 11ME is configured to, for the artist 11AR and the adjacent audiences 11AJ within the range that the viewer 11ME can see, acquire and render their object data, while for the nonadjacent audiences 11NJ, using their minimized object data or not using their object data, so that unwanted traffic can be reduced and the load of rendering processing can be reduced.

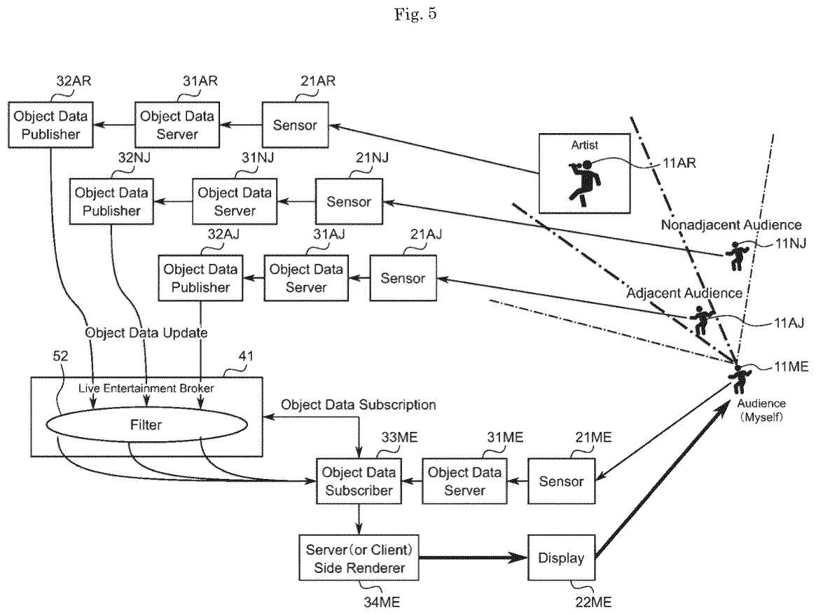

With reference to FIG. 5, operations of the client device 20 and the server device 30 for each of a viewer 11ME, an artist 11AR, an adjacent audience 11AJ, and a nonadjacent audience 11NJ will be described.

In FIG. 5, symbols “ME”, “AR”, “AJ”, and “NJ” are assigned to the respective components in the client device 20 and the server device 30, which correspond to the viewer 11ME, the artist 11AR, the adjacent audience 11AJ, and the nonadjacent audience 11NJ, so that they are distinguished from each other. For example, a sensor 21ME and a display 22ME represent the sensor 21 and the display 22 of the client device 20 for the viewer 11ME, respectively. An object data server 31ME, an object data subscriber 33ME, and a server side renderer 34ME represent the object data server 31, the object data subscriber 33, and the server side renderer 34 of the server device 30 for the viewer 11ME, respectively. A sensor 21AR, an object data server 31AR, and an object data publisher 32AR represent the sensor 21 of the client device 20, the object data server 31 of the server device 30, and the object data publisher 32 of the server device 30 for the artist 11AR, respectively. The same applies to the adjacent audience 11AJ and the nonadjacent audience 11NJ.

The sensor 21AR for the artist 11AR generates sensor data obtained by sensing the artist 11AR, for example, an RGB image of the artist 11AR, and supplies the sensor data to the object data server 31AR.

The object data server 31AR generates object data from the sensor data sent from the sensor 21AR, stores the generated object data in an internal storage unit, and forwards the generated object data to the object data publisher 32AR.

The object data publisher 32AR extracts information necessary for object rendering from the object data supplied from the object data server 31AR and sends the information to the live entertainment broker 41.

The object data publisher 32AR checks the object data in the object data server 31AR at the point when the update of the object data generated based on the sensor data sequentially forwarded from the sensor 21AR is completed (at the snapshot at a predetermined cycle), extracts object data which may affect rendering, and forwards the extracted object data to the live entertainment broker 41. When object data in near future is also predicted and generated, that object data is also extracted and forwarded to the live entertainment broker 41.

The operations of the sensors 21, the object data servers 31, and the object data publishers 32 for the adjacent audience 11AJ and the nonadjacent audience 11NJ are basically the same as those for the artist 11AR described above, except that the target object is different, and thus, their description is not repeated. However, the artist 11AR is captured and forwarded with maximum quality because the artist 11AR is of the greatest interest in the live entertainment service, while the adjacent audience 11AJ and the nonadjacent audience 11NJ may be captured and forwarded with minimum quality (to some degree).

On the other hand, the sensor 21ME for the viewer 11ME generates sensor data obtained by sensing the viewer 11ME, for example, an RGB image of the viewer 11ME, and supplies the sensor data to the object data server 31ME.

The object data server 31ME generates object data from the sensor data sent from the sensor 21ME, stores the generated object data in an internal storage unit, and forwards the generated object data to the object data subscriber 33ME.

The object data subscriber 33ME detects a change in the viewpoint information of the viewer 11ME based on the object data supplied from the object data server 31ME. The object data subscriber 33ME then negotiates with the subscription manager 51 (not illustrated in FIG. 5) of the live entertainment broker 41 for the display level of the object(s) at the viewpoint or within the visible scope, based on the detected viewpoint information of the viewer 11ME.

The object data subscriber 33ME subscribes (requests) to the live entertainment broker 41 to deliver only the object data (including object data predicted in near future) related to the target objects necessary for itself (the viewer 11ME), such as the artist 11AR and the surrounding audiences 11AU. This subscribing (subscription) is executed when the viewer object observed by the sensor 21ME changes, for example, each time the state of the viewer's line of sight changes or each time the interest or degree of interest on the target object(s) changes due to a change in the viewer's attitude. Of course, such a change in attitude is also detected by the sensor 21ME, or sent from the sensor 21ME to the object data server 31ME via an input device (such as a remote controller) that generates sensor data.

The subscription manager 51 of the live entertainment broker 41 negotiates with the object data subscriber 33 for the display level of the object(s). Specifically, a filter condition is determined for how to filter each of the objects such as the artist 11AR, the adjacent audience 11AJ, and the nonadjacent audience 11NJ, which are present at the viewpoint or within the visible scope of the viewer 11ME.

The filter 52 of the live entertainment broker 41 filters, based on the determined filter condition, the object data of objects that are at the viewpoint or within the visible scope of the viewer 11ME, of the object data supplied from the object data publisher 32AR for the artist 11AR, the object data publishers 32AJ for the adjacent audience 11AJ, and the object data publishers 32NJ for the nonadjacent audience 11NJ. The filter 52 sends the filtered object data to the object data subscriber 33ME for the viewer 11ME.

The live entertainment broker 41 filters object data sent from a number of object data publishers 32 on the basis of object data subscriptions to object state information of the target objects gathered from the object data subscribers 33 for the audience 11ME, the adjacent audience 11AJ, and the nonadjacent audience 11NJ, and forwards the filtered object data to the object data subscriber 33ME for the viewer 11ME. In this filtering, the object data is modified by weighting as appropriate in consideration of the difference in required quality due to the difference between the adjacent audience 11AJ and the nonadjacent audience 11NJ, and the resulting object data is forwarded.

For example, the orientation of the face of the viewer 11ME at a predetermined time is detected based on the sensor data generated by the sensor 21ME. The object data subscriber 33ME can identify the viewpoint or visible scope of the viewer 11ME from the object data generated by the object data server 31ME. The object data subscriber 33ME notifies (informs) the live entertainment broker 41 of the viewer's viewpoint or visible scope to request the live entertainment broker 41 to identify the objects that are at the viewpoint or within the visible scope. The subscription manager 51 of the live entertainment broker 41 returns the identifiers of the objects that are at the viewpoint or within the visible scope and attribute of each of the objects such as whether it is an adjacent audience 11AJ or nonadjacent audience 11NJ, and performs negotiation for a filter condition as to how to filter the object data of each object. A final object data subscription is determined as a result of the negotiation. Various preferences of the viewer 11ME are also reflected in the object data subscription.

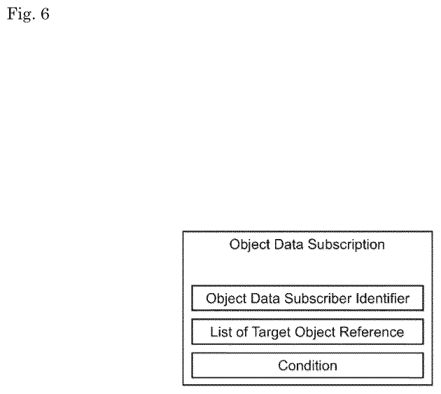

FIG. 6 illustrates information included as an object data subscription. The object data subscription includes an object data subscriber identifier (“Object Data Subscriber Identifier”), a target object reference list (“List of Target Object Reference”), and a condition (“Condition”). The object data subscriber identifier represents the identifier of the object data subscriber 33 that registers the object data subscription. The target object reference list includes (a list of) identifiers that identify the objects to be acquired. The condition includes various filter conditions for the object data to be acquired.

Note that how much the subscription manager 51 takes into account the intention of the viewer 11ME depends on how to operate the service. There are a case where the intentions on the individual client device 20 sides may be taken into account in detail, and a case where with ignoring the intentions of the client device 20 sides, the details of each object data subscription may be determined from a broader perspective, taking into account various factors such as overall service operating costs and load conditions. The object data subscriptions are frequently updated to keep up-to-date individual viewpoint information for the viewer 11ME, the artist 11AR, and the surrounding audiences 11AU.

Returning to FIG. 5, the object data subscriber 33ME receives the object data at the viewpoint or within the visible scope, which is sent from the filter 52 of the live entertainment broker 41, and supplies the object data to the server side renderer 34.

The server side renderer 34ME generates rendering data based on the object data at the viewpoint or within the visible scope, which is supplied from the object data subscriber 33ME, and encodes the rendering data using a predetermined compression and encoding method. The server side renderer 34ME then sends the encoded stream data to the display 22ME for the viewer 11ME.

As will be described later, instead of the server device 30, the client device 20 may have the rendering function (the function of performing GPU-dependent polygon/texture conversion and GPU transfer of the object(s) at the viewpoint or within the visible scope and outputting a 2D image to a frame buffer). In that case, the renderer of the client device 20 generates rendering data and forwards the rendering data to the display 22ME.

The display 22ME receives the rendering data sent from the server side renderer 34ME, decodes and displays the received rendering data. The display 22ME displays a live video of the object of the artist 11AR at the virtual concert venue 12. The objects of the adjacent audience 11AJ and the nonadjacent audience 11NJ are also displayed on the display 22ME according to the viewpoint or visible scope of the viewer 11ME.

In the data processing system 1 described above, since each of the adjacent audience 11AJ and the nonadjacent audience 11NJ may become the viewer 11ME, the object data server 31 that generates object data and the server side renderer 34 that acquires and renders the object data are configured to have a relationship of n:m (n>0, m>0).

According to the data processing system 1, the object data publishers 32 and the object data subscribers 33 for the artist 11AR and the surrounding audiences 11AU and the live entertainment broker 41 are introduced. The object data publishers 32 and the object data subscribers 33 alleviate excessive traffic between the object data servers 31 for the artist 11AR and the surrounding audiences 11AU and the server side renderer 34 for the viewer 11ME. The live entertainment broker 41 performs a filtering function for traffic. Object state information traffic between the server devices 30 that send and receive the object data of objects in the virtual space in the live entertainment service is filtered using a combination of predetermined conditions, so that the excessive traffic can be reduced and the rendering processing load can be reduced. Thus, it is possible to reduce the traffic of the object data that constitutes the virtual space.

For the object state information traffic, there are a case where the entire original data of state information of the current object is forwarded periodically from session establishment to release, a case where the entire original data is first forwarded and then, only when the original data is updated, the update difference is sequentially forwarded, and a case of combination where the two cases are switched at a predetermined time interval.

In the transmission of the object data in the live entertainment service, the data required by the viewer 11ME includes: a set of high-quality (wide band) sensor data obtained by observing the artist 11AR and object data generated based on the sensor data; a set of sensor data with a certain level of quality obtained by observing an adjacent audience 11AJ near the viewer 11ME in the virtual space and object data generated based on the sensor data; and a set of low-quality sensor data obtained by observing a nonadjacent audience 11NJ that is at the viewpoint or within the visible scope in the virtual space and object data generated based on the sensor data. For the viewer 11ME focused on here, the quality of the sensor data obtained by observing a nonadjacent audience 11NJ is allowed to be low, while for other audiences, the nonadjacent audience 11NJ is an adjacent audience 11AJ, which may require a certain quality of sensor data. Therefore, for all audiences, a certain quality of sensor data is acquired fairly to generate object data.

### <3. Object Data Publication>

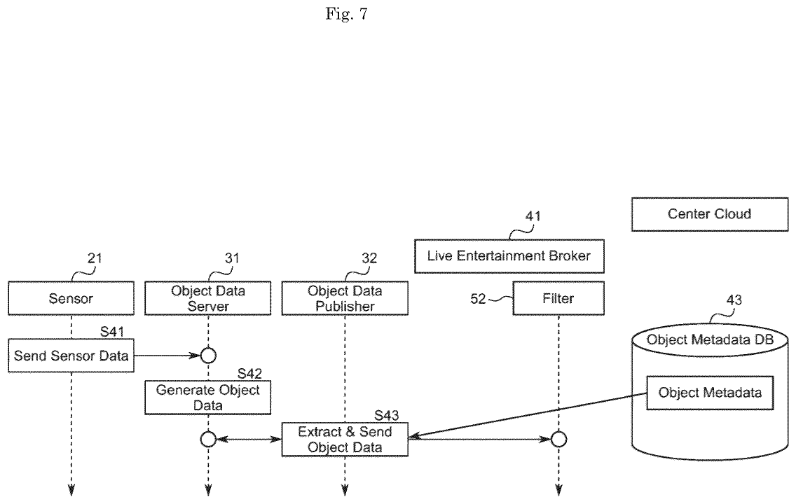

Next, with reference to the flowchart of FIG. 7, processing prior to the object data of the artist 11AR and the audience 11AU being published to the live entertainment broker 41 will be described. This processing is always repeated.

First, in step S41, the sensor 21 of the client device 20 acquires sensor data obtained by observing the target subject and sends the sensor data to the object data server 31 of the corresponding server device 30.

In step S42, the object data server 31 receives the sensor data sent from the sensor 21 and generates object data based on the sensor data.

In step S43, the object data publisher 32 checks the object data at a predetermined cycle, and when the update of all the object data is completed, extracts the entire updated object data or only the updated part of the object data, stores in an object data publication structure the updated object data along with the identifier for identifying the corresponding object, and forwards the resulting data to the live entertainment broker 41. When object data in near future is also predicted and generated, that object data is also extracted and forwarded to the live entertainment broker 41.

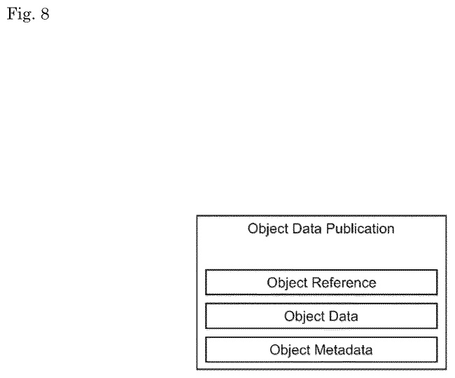

FIG. 8 illustrates an example of the object data publication structure for forwarding object data.

The object data publication structure has object reference, object data, and object metadata. The object reference stores an identifier for identifying this object.

The object data stores the entire updated object data or only the updated part of the object data. The object metadata stores metadata for making it possible to refer to all attributes related to this object. It also includes, for example, queries for referring to the virtual space DB 42 and queries for referring to various attributes of other objects stored in the object metadata DB 43. This object metadata is used for filtering in the filter 52 of the live entertainment broker 41.

The object data publisher 32 being interposed between the object data server 31 for the artist 11AR or the audience 11AU and the live entertainment broker 41 can reduce excessive traffic therebetween.

### <4. Object Data Forward Processing Before Rendering>

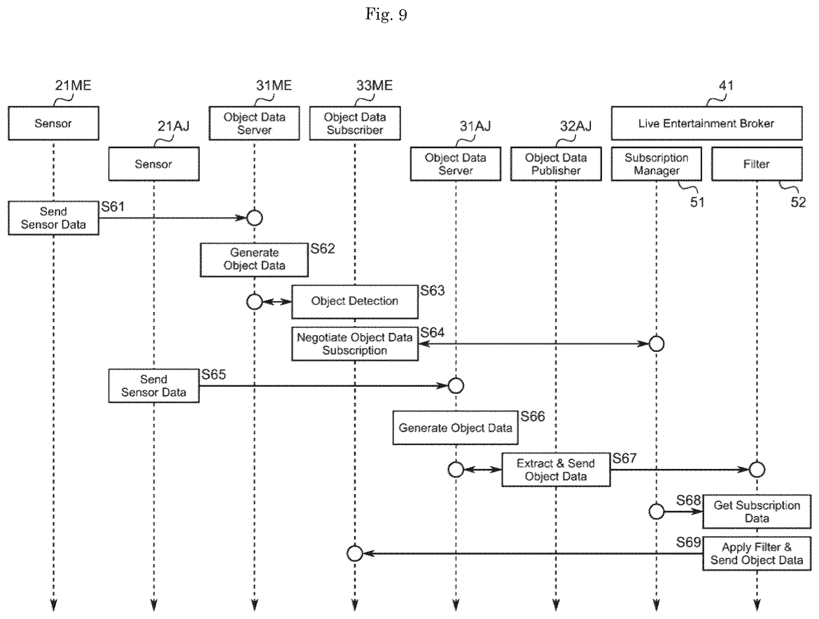

Next, with reference to the flowchart of FIG. 9, the object data forward processing immediately before rendering executed by the client device 20 for the viewer 11ME will be described.

First, in step S61, the sensor 21ME of the client device 20ME for the viewer 11ME acquires sensor data obtained by observing a target subject, and sends the sensor data to the object data server 31ME of the corresponding server device 30ME.

In step S62, the object data server 31ME receives the sensor data sent from the sensor 21ME and generates object data based on the sensor data. The generated object data is stored in an internal storage unit. The state information stored in the virtual space DB 42 in the center cloud is also referred to in generating the object data.

In step S63, the object data subscriber 33ME checks the object data generated by the object data server 31ME to detect a change in the viewpoint information of the viewer 11ME.

In step S64, the object data subscriber 33ME negotiates with the subscription manager 51 of the live entertainment broker 41 for the display level of the object(s) at the viewpoint or within the visible scope, based on the detected viewpoint information of the viewer 11ME. As a result of the negotiation, the object data subscription illustrated in FIG. 6 is determined.

On the other hand, in step S65, the sensor 21AJ of the client device 20AJ for the adjacent audience 11AJ near the viewer 11ME acquires sensor data obtained by observing the target subject, and sends the sensor data to the object data server 31AJ of the corresponding server device 30AJ.

In step S66, the object data server 31AJ receives the sensor data sent from the sensor 21AJ and generates object data based on the sensor data.

In step S67, the object data publisher 32AJ checks the object data at a predetermined cycle, and when the update of all the object data is completed, and extracts the entire updated object data or only the updated part of the object data. The object data publisher 32AJ then stores in the object data publication structure the updated object data and forwards the object data to the live entertainment broker 41. When object data in near future is also predicted and generated, that object data is also extracted and forwarded to the live entertainment broker 41.

In step S68, the filter 52 of the live entertainment broker 41 acquires (gets) the object data subscription determined through the negotiation from the subscription manager 51.

In step S69, the filter 52 filters the object data based on the filter condition determined by the subscription manager 51. The filter 52 then sends the filtered object data to the object data subscriber 33ME for the viewer 11ME.

The object data subscriber 33ME receives the object data at the viewpoint or within the visible scope, which is sent from the filter 52 of the live entertainment broker 41, and supplies the object data to the server side renderer 34.

### <5. Explanation of Rendering Processing>

Next, rendering processing will be described.

In the processing described above, the server side renderer 34ME is deployed on the edge cloud, and the rendering processing is executed on the edge cloud. Accordingly, the live entertainment broker 41 collects and filters the object data forwarded from a large number of object data publishers 32, and forwards the filtered object data to the object data subscriber 33ME. The object data subscriber 33ME receives the object data at the viewpoint or within the visible scope and supplies the object data to the server side renderer 34 on the edge cloud. The server side renderer 34ME generates rendering data based on the object data supplied from the object data subscriber 33ME.

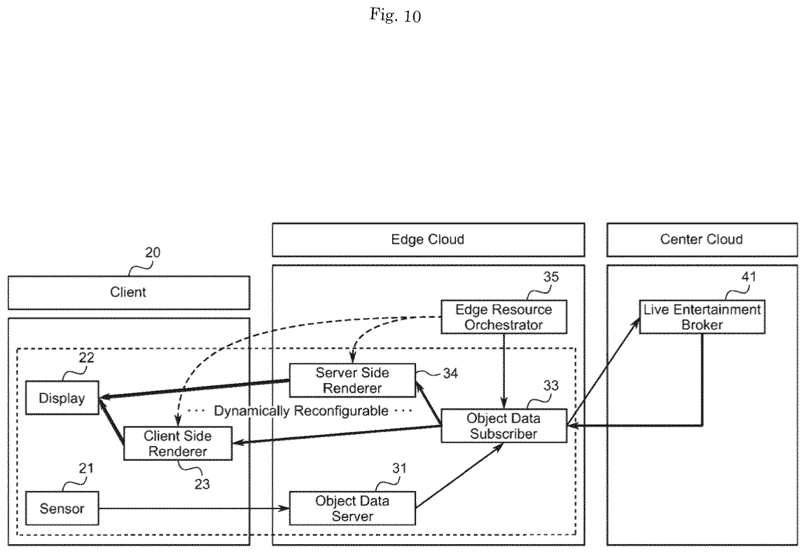

However, a configuration can be provided in which the client device 20 has a renderer to allow the rendering processing to be executed on the client side as well, so that it is possible to select whether to execute the rendering on the server side or on the client side as appropriate. In a case where this configuration is adopted, as illustrated in FIG. 10, a client side renderer 23 is provided in the client device 20, and an edge resource orchestrator 35 is provided in the server device 30 on the edge cloud.

The edge resource orchestrator 35 monitors the status of load of the edge cloud and the status of traffic between the client device 20 and the edge cloud, and determines whether the rendering is to be executed on the server side or the client side. For example, the edge resource orchestrator 35 dynamically changes the place where the rendering is executed, depending on the types of object data (for example, visible data, audible data, etc.), the status of traffic between the client device 20 and the edge cloud, the status of load of computing resources and storage resources of the edge cloud, and the like. The edge resource orchestrator 35 causes the renderer to run at the optimum execution place, and notifies (informs) the object data subscriber 33 of the forward destination of the object data. The object data subscriber 33 sends the object data at the viewpoint or within the visible scope to the notified renderer. The client side renderer 23 receives the object data at the viewpoint or within the visible scope, which is sent from the object data subscriber 33, generates rendering data, and supplies the rendering data to the display 22.

The rendering is executed on the client side when the traffic of object data forwarded from the object data subscriber 33 on the edge cloud to the client side renderer 23 of the client device 20 in the case of client side rendering is extremely less than the traffic of encoded stream (baseband stream if not encoded) forwarded from the server side renderer 34 on the edge cloud to the display 22 of the client device 20 in the case of server side rendering. In other words, the rendering is executed on the client side when the amount of forwarded object data (polygon data, texture data, etc.) is extremely small compared to rendered data (baseband data).

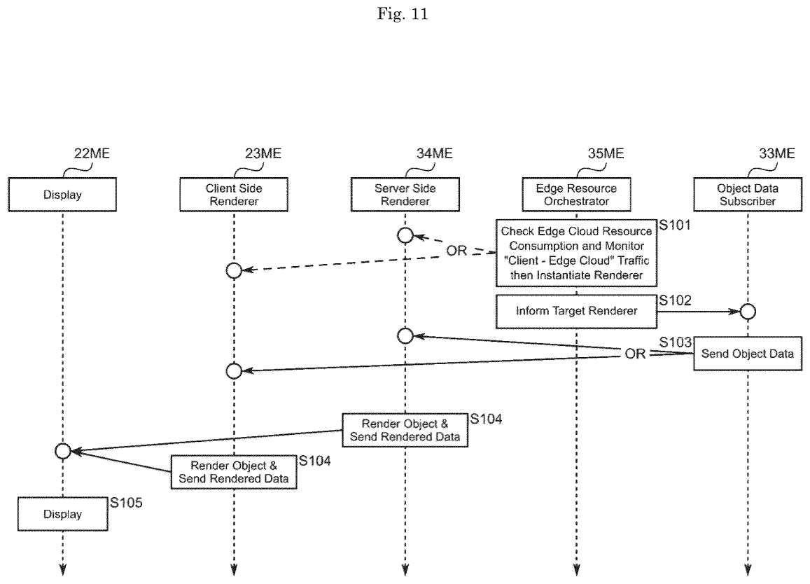

With reference to the flowchart of FIG. 11, rendering processing for rendering the object data of the viewer 11ME while dynamically changing the place where the renderer runs will be described.

In step S101, the edge resource orchestrator 35ME for the viewer 11ME determines the place where the rendering is to be executed, according to the status of load of the computational resources and storage resources of the edge cloud, the status of traffic between the client device 20ME and the edge cloud, and the like. The edge resource orchestrator 35ME then causes the renderer to run at the determined execution place. If it is determined to perform the rendering on the server side, the server side renderer 34ME executes it. If it is determined to perform the rendering on the client side, the client side renderer 23ME of the client device 20ME executes it.

In step S102, the edge resource orchestrator 35ME notifies (informs) the object data subscriber 33ME of the renderer (target renderer) to which the object data is to be forwarded. For example, the address of the renderer to which the object data is to be forwarded is notified.

In step S103, the object data subscriber 33ME receives the notification about the target renderer from the edge resource orchestrator 35ME, and sends the object data at the viewpoint or within the visible scope to the notified renderer.

In step S104, the activated server side or client side renderer generates rendering data and forwards the rendering data to the display 22ME. Specifically, when the server side renderer 34ME executes, the server side renderer 34ME receives the object data at the viewpoint or within the visible scope, which is sent from the object data subscriber 33ME, generates rendering data, and supplies the rendering data to the display 22ME. On the other hand, when the client side renderer 23ME executes, the client side renderer 23ME receives the object data at the viewpoint or within the visible scope, which is sent from the object data subscriber 33ME, generates rendering data, and supplies the rendering data to the display 22ME.

In step S105, the display 22ME receives and displays the rendering data.

While the processing of steps S101 to S105 in FIG. 11 is repeated, the place where the rendering is executed location is dynamically changed according to the status of traffic and the like.

### <6. Rendering Data Aggregation Processing>

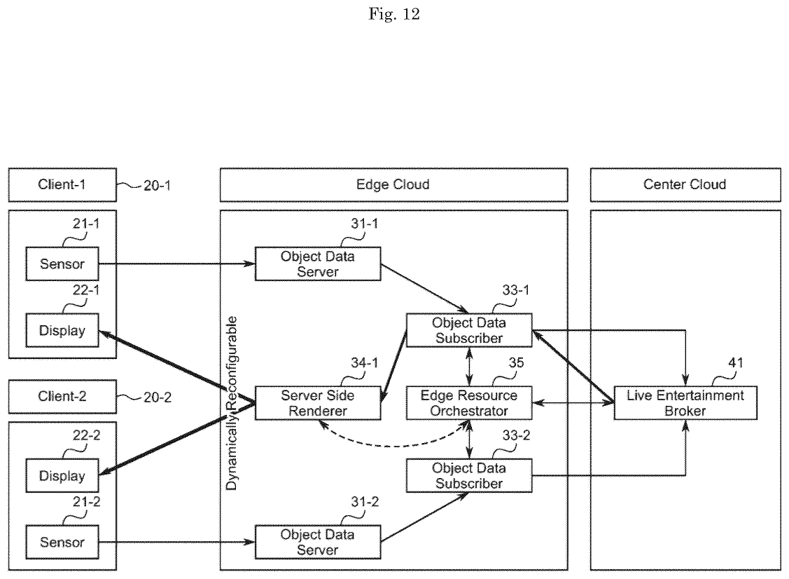

Next, with reference to FIG. 12, rendering data aggregation processing for making common rendering data and sending the rendering data to each of the client devices 20 for a plurality of viewers 11ME who are close to each other will be described.

For example, in a case where two viewers 11ME are located close to each other in the virtual space and the server side renderers 34 for the two viewers are running on the same edge server, the details of the object data subscriptions for the two viewers 11ME are almost the same. In other words, the viewpoints or visible scopes of the two viewers 11ME are almost the same. Therefore, the client devices 20 for the two viewers can share a viewpoint or visible scope, and rendering data generated by the server side renderer 34 for one of the two viewers can be sent to both the client devices 20.

In FIG. 12, the rendering data generated by a server side renderer 34-1 corresponding to a client device 20-1, which is one of the client device 20-1 for a viewer 11ME-1 and a client device 20-2 for a viewer 11ME-2, is sent to both a display 22-1 of a client device 20-1 and a display 22-2 of a client device 20-2.

If there is little difference in viewpoint or visible scope between the two viewers 11ME-1 and 11ME-2 who are close to each other when they views a distant object, the details of conditions (“Condition” in FIG. 6) presented from an object data subscriber 33-1 for the viewer 11ME-1 and an object data subscriber 33-2 for the viewers 11ME-2 to the live entertainment broker 41 through their object data subscriptions are very close to each other. Therefore, the live entertainment broker 41 determines the details of their object data subscriptions to be substantially the same, and makes a common condition by overwriting the details of one condition with the details of the other condition. Alternatively, the live entertainment broker 41 may synthesize the conditions for the two viewers 11ME-1 and 11ME-2 to make a common condition, and generate a new condition for an intermediate viewpoint or visible scope of the two viewers.

The live entertainment broker 41 notifies the edge resource orchestrator 35 of the common rendering data. The edge resource orchestrator 35 notifies the object data subscribers 33-1 and 33-2 of the common rendering data, and causes one server side renderer 34 to run on the edge cloud.

In the example of FIG. 12, the common rendering data corresponding to the rendering data for the viewpoint or visible scope of the viewer 11ME-1 is sent to the client devices 20 for the viewers 11ME-1 and 11ME-2. In this case, the live entertainment broker 41 sends the object data at the viewpoint or within the visible scope to the object data subscriber 33-1. The object data subscriber 33-1 receives the object data and forwards the object data to the server side renderer 34-1. The server side renderer 34-1 generates rendering data based on the object data supplied from the object data subscriber 33-1, and sends the rendering data to each of the display 22-1 of the client device 20-1 and the display 22-2 of the client device 20-2.

The edge resource orchestrator 35 also notifies the object data subscriber 33-2 of no object data to be received. The object data subscriber 33-2 stops waiting for object data.

The live entertainment broker 41 only needs to send the object data to the object data subscriber 33-1, and therefore traffic in the edge cloud can be reduced. In addition, only one server side renderer 34 needs to be activated, and therefore the load on the edge cloud can be reduced and the resources of the edge cloud can be saved.

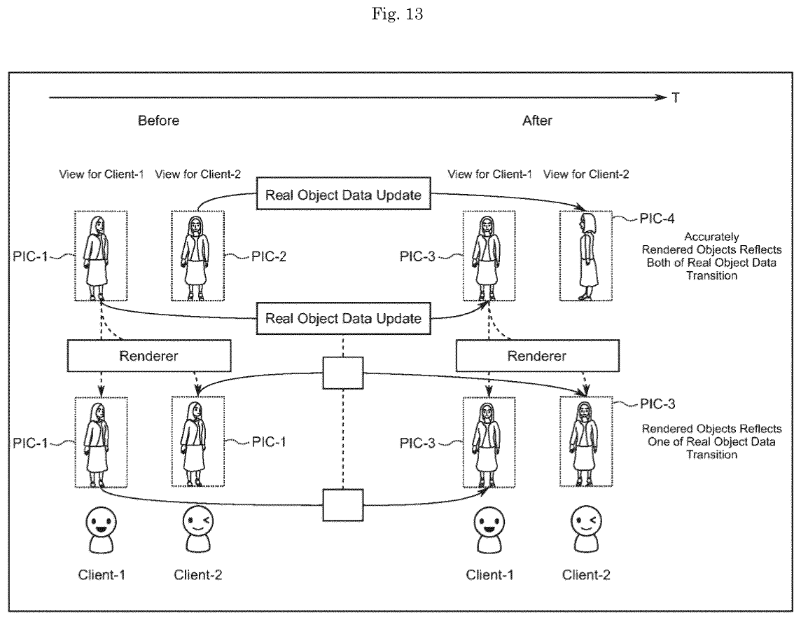

FIG. 13 is a diagram illustrating 2D images displayed on the displays 22-1 and 22-2 for the viewers 11ME-1 and 11ME-2 by the rendering data aggregation processing.

Images PIC-1 and PIC-2 are original live videos when the viewers 11ME-1 and 11ME-2 both look at a distant nonadjacent audience 11NJ at a certain time T1 (Before). The images PIC-1 and PIC-2 are slightly different images due to the difference in viewpoint information between the viewers 11ME-1 and 11ME-2.

However, when the rendering data aggregation processing performs the commonization with the condition for the viewer 11ME-1, the rendering data corresponding to the condition for the viewer 11ME-1 is sent to each of the display 22-1 of the client device 20-1 and the display 22-2 of the client device 20-2. Specifically, as illustrated in the lower part, both the displays 22-1 and 22-2 display the image PIC-1.

It is now assumed that at a time T2 (After) after the time T1, the object data is updated, and the original live images when the viewers 11ME-1 and 11ME-2 look at the distant nonadjacent audience 11NJ are images PIC-3 and PIC-4, respectively. The images PIC-3 and PIC-4 are also slightly different images due to the difference in viewpoint information between the viewers 11ME-1 and 11ME-2.

However, the image PIC-3 corresponding to the condition for the viewer 11ME-1 is displayed on both the displays 22-1 and 22-2 by the rendering data aggregation processing.

In this way, the rendering data aggregation processing causes the same 2D image to be displayed on both the displays 22-1 and 22-2.

In a case where instead of making a common condition by overwriting the details of one condition with the details of the other condition, the two conditions are synthesized to make a new common condition corresponding to an intermediate viewpoint or visible scope of the two viewers, a 2D image is generated by synthesizing the two pieces of object data and displayed.

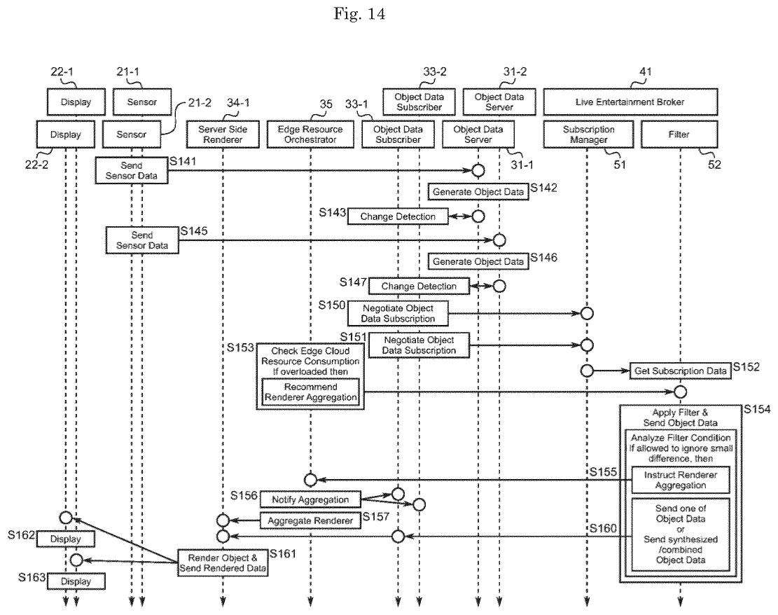

With reference to the flowchart of FIG. 14, rendering processing in a case where the rendering data aggregation processing is executed for the viewers 11ME-1 and 11ME-2 will be described.

First, in step S141, the sensor 21-1 of the client device 20-1 for the viewer 11ME-1 acquires sensor data obtained by observing the target subject and sends the sensor data to the object data server 31-1 of the corresponding server device 30-1.

In step S142, the object data server 31-1 receives the sensor data sent from the sensor 21-1, generates object data based on the sensor data, and stores the object data in an internal storage unit.

In step S143, the object data subscriber 33-1 checks the object data generated by the object data server 31-1 to detect a change in the viewpoint information of the viewer 11ME-1.

On the other hand, in step S145, the sensor 21-2 of the client device 20-2 for the viewer 11ME-2 acquires sensor data obtained by observing the target subject and sends the sensor data to the object data server 31-2 of the corresponding server device 30-2.

In step S146, the object data server 31-2 receives the sensor data sent from the sensor 21-2, generates object data based on the sensor data, and stores the object data in an internal storage unit.

In step S147, the object data subscriber 33-2 checks the object data generated by the object data server 31-2 to detect a change in the viewpoint information of the viewer 11ME-2.

The processing of steps S141 to S143 for the viewer 11ME-1 and the processing of steps S145 to S147 for the viewer 11ME-2 can be executed in parallel.

In step S150, the object data subscriber 33-1 negotiates with the subscription manager 51 of the live entertainment broker 41 for the display level of the object(s) at the viewpoint or within the visible scope, based on the detected viewpoint information of the viewer 11ME-1. As a result of the negotiation, the object data subscription is determined.

In step S151, the object data subscriber 33-2 negotiates with the subscription manager 51 of the live entertainment broker 41 for the display level of the object(s) at the viewpoint or within the visible scope, based on the detected viewpoint information of the viewer 11ME-2. As a result of the negotiation, the object data subscription is determined.

The processing of step S150 and the processing of step S151 can be executed in parallel.

In step S152, the filter 52 of the live entertainment broker 41 acquires (gets) the object data subscription determined through the negotiation from the subscription manager 51.

In step S153, the edge resource orchestrator 35 monitors the status of overall traffic in the edge cloud, the status of traffic between the edge resource orchestrator 35 and the client device 20 under its control, and the status of load in the edge cloud (“Check Edge Cloud Resource Consumption”). As a result of monitoring, if the edge resource orchestrator 35 determines that the load on the edge cloud is large, the edge resource orchestrator 35 recommends that the rendering processing commonization on the edge cloud is to be executed to the filter 52 of the live entertainment broker 41 (“Recommend Renderer Aggregation”).

In step S154, the filter 52 of the live entertainment broker 41 determines in the filtering processing that the condition for the object data subscription based on the viewpoint information of the viewer 11ME-1 and the condition for the object data subscription based on the viewpoint information for the viewer 11ME-2 may be almost the same, a common condition is made from the details of the two conditions. By unifying the two conditions into the details of one of the conditions or synthesizing the two conditions, a common condition is made from the details of the two conditions.

Then, in step S155, the filter 52 notifies the edge resource orchestrator 35 to make common rendering data (“Instruct Renderer Aggregation”).

In step S156, the edge resource orchestrator 35 notifies the object data subscribers 33-1 and 33-2 of the common rendering data (“Notify Aggregation”). Subsequently, in step S157, the edge resource orchestrator 35 causes one server side renderer 34-1 that aggregately processes the rendering data for the viewers 11ME-1 and 11ME-2 to run on the edge cloud (“Aggregate Renderer”).

For the condition being unified into the details of the condition for either the viewer 11ME-1 or the viewer 11ME-2, in step S160, the filter 52 generates object data at the viewpoint or within the visible scope by filtering with the adopted condition. On the other hand, for the condition being unified into one condition by synthesizing the two conditions, in step S160, the filter 52 synthesizes the pieces of object data for the viewers 11ME-1 and 11ME-2 to generate filtered object data at the viewpoint or within the visible scope. The generated object data at the viewpoint or within the visible scope is sent to the server side renderer 34-1 via the object data subscriber 33-1.

In step S161, the server side renderer 34-1 acquires the sent object data, generates rendering data, and sends the rendering data to each of the display 22-1 for the viewer 11ME-1 and the display 22-2 for the viewer 11ME-2.

In step S162, the display 22-1 for the viewer 11ME-1 acquires the rendering data and displays a 2D image. In step S163, the display 22-2 for the viewer 11ME-2 acquires the rendering data and displays a 2D image. The 2D images displayed on the displays 22-1 and 22-2 are the same image.

As described above, the rendering processing for performing the rendering data aggregation processing is executed with the server side renderer 34 being shared by a plurality of client devices 20.

### <7. Rendering Data Aggregation Processing Depending on Data Type>

The rendering data aggregation processing described above can be executed depending on data type. For example, the rendering data aggregation processing may be determined to be executed or not to be executed depending on whether the rendering data is video data, which is visible data, or audio data, which is audible data.

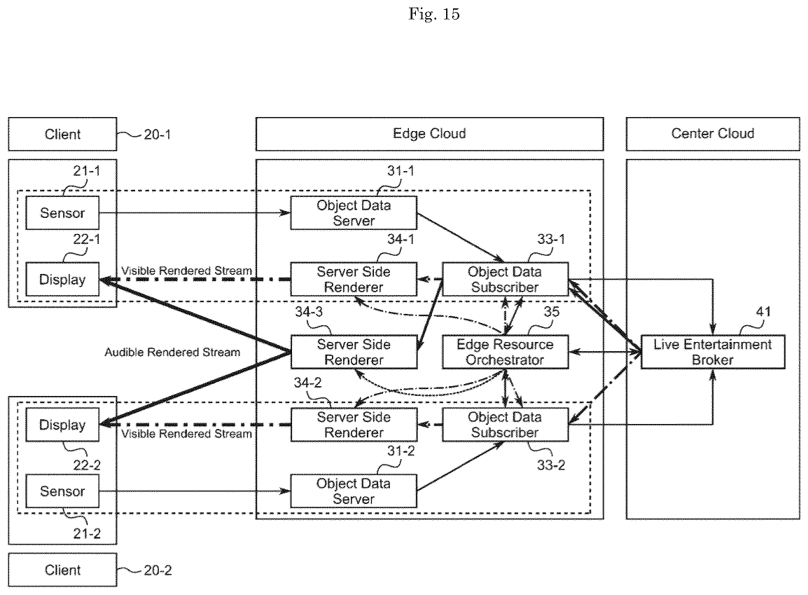

For example, as illustrated in FIG. 15, audio data, which is audible data, is subjected to the rendering data aggregation processing in the same manner as the processing described with reference to FIGS. 12 to 14. Specifically, the server side renderer 34-3 generates common rendering data, for example, rendering data corresponding to the viewpoint or visible scope of the viewer 11ME-1, and sends the generated rendering data to the display 22-1 for the viewer 11ME-1 and the display 22-2 for the viewer 11ME-2.

On the other hand, video data, which is visible data, is not subjected to the rendering data aggregation processing, and the server side renderer 34-1 corresponding to the viewer 11ME-1 and the server side renderer 34-2 corresponding to the viewer 11ME-2 separately generate rendering data for the video data. The rendering data generated by the server side renderer 34-1 is sent to the display 22-1 for the viewer 11ME-1, and the rendering data generated by the server side renderer 34-2 is sent to the display 22-2 for the viewer 11ME-2.

As described above, the criteria for determining the identity of object data subscriptions may differ depending on the type of data.

### <8. Combination of Rendering Data Aggregation Processing and Client Side Renderer>

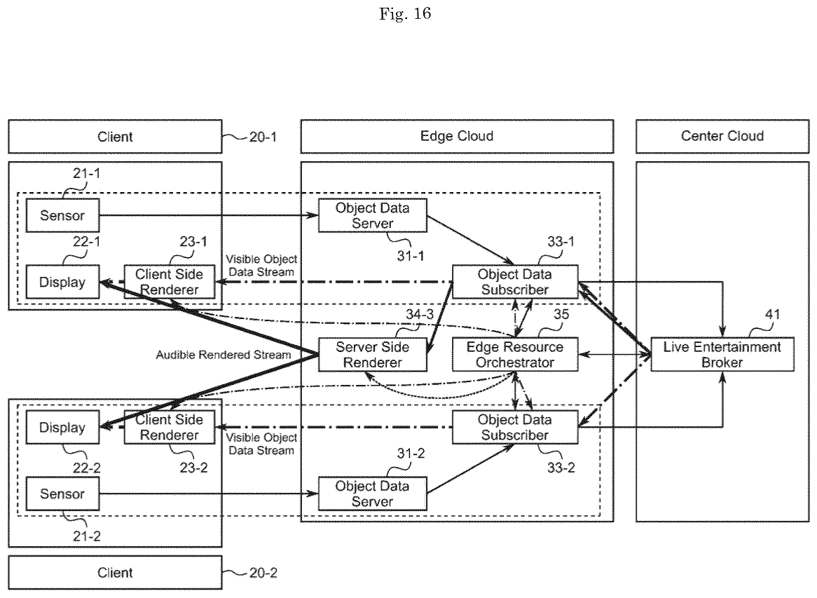

When the resources (computational resources and storage resources) on a client side are available, and traffic of rendered data of visible data between the corresponding client device 20 and the edge cloud may have a large impact on congestion, video data, which is visible data, may be rendered on the client side, as illustrated in FIG. 16.

Specifically, as illustrated in FIG. 16, for audio data, which is audible data, the rendering data aggregation processing described above is executed, and the rendering data generated by the server side renderer 34-3 is sent to the display 22-1 for the viewer 11ME-1 and the display 22-2 for the viewer 11ME-2.

On the other hand, for video data, which is visible data, different pieces of object data for the viewer 11ME-1 and the viewer 11ME-2 are sent to the client side renderers 23-1 and 23-2, respectively. Specifically, the filter 52 of the live entertainment broker 41 sends the object data for the viewer 11ME-1 to the client side renderer 23-1 via the object data subscriber 33-1. The filter 52 of the live entertainment broker 41 sends the object data for the viewer 11ME-2 to the client side renderer 23-2 via the object data subscriber 33-2.

In this manner, whether the rendering is to be executed on the client side or on the server side may be selected depending on data type, and in addition, the rendering data aggregation processing may be executed in the rendering on the server side.

As described above, in the data processing system 1, it is possible to flexibly (dynamically) select one of: whether to cause one of the server side renderer 34 and the client side renderer 23 to run, whether to cause both to run, whether to perform the aggregation processing, and others. For example, the processing can be selected according to the status of traffic between the client device 20 and the edge cloud, data type (for example, based on the difference between visible data and audible data), rendered data to the client devices 20, and the degree of object data in common.

### <9. Local Live Entertainment Broker>

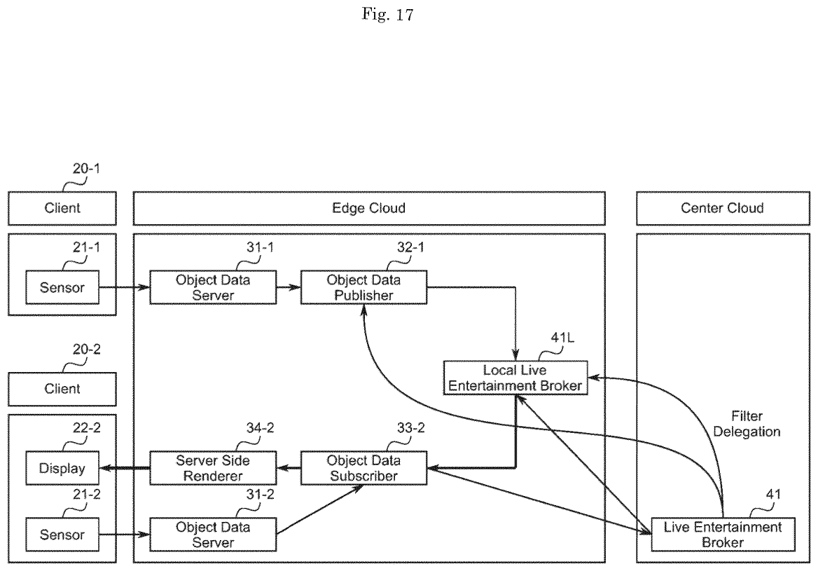

Next, with reference to FIG. 17, the function of deploying a part of the functions of the live entertainment broker 41 to the edge cloud in a distributed manner will be described.

In a case where all traffic is closed between the object data publishers 32 and the object data subscribers 33 on one edge cloud, the function of the filter 52 of the live entertainment broker 41 can be deployed on that edge cloud.

Specifically, as illustrated in FIG. 17, a local live entertainment broker 41L is deployed on the edge cloud as a clone of the live entertainment broker 41. The object data publisher 32-1 sends the entire updated object data or only the updated part of the object data to the local live entertainment broker 41L. The local live entertainment broker 41L sends the object data filtered according to the object data subscription to the object data subscriber 33-2 on the same edge cloud. The object data subscriber 33-2 receives the object data at the viewpoint or within the visible scope of the viewer 11ME-2 and supplies the object data to the server side renderer 34-2.

This deployment of the local live entertainment broker 41L on the edge cloud allows the object data to be returned back in the edge cloud. This makes it possible to cover delay requirements and the like and to reduce unwanted traffic in the cloud. The local live entertainment broker 41L can be deployed on the corresponding edge cloud that returns object data as a clone of the live entertainment broker 41, and can deploy the function of the filter 52 to be executed in a distributed manner.

The local live entertainment broker 41L can make a copy of traffic that does not pass through the live entertainment broker 41 and send the copy to the live entertainment broker 41 on the center cloud. This allows the live entertainment broker 41 to acquire data for security monitoring and/or statistical purposes. Whether or not to send the copy of traffic to the live entertainment broker 41 can be selected by a setting of “partially synchronized” or “not synchronized”.

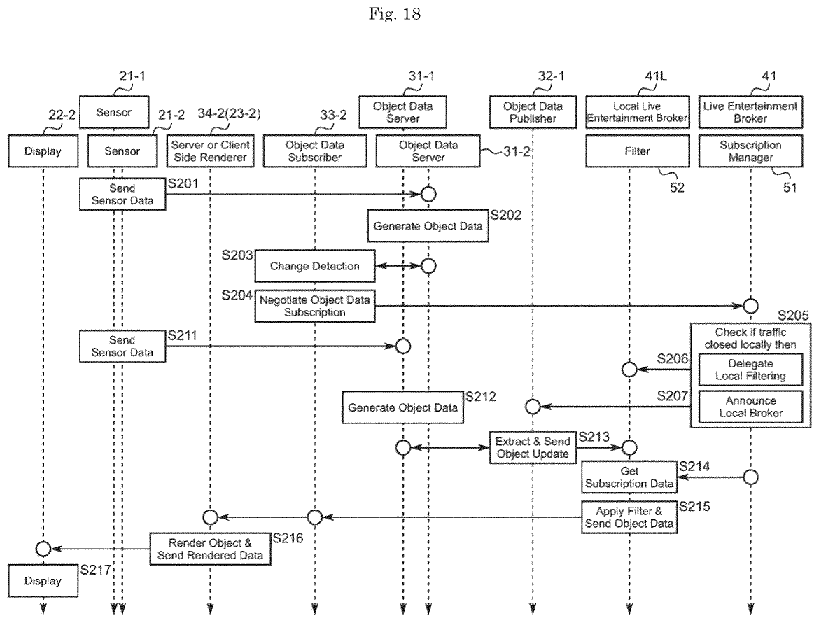

With reference to the flowchart of FIG. 18, object data forward processing in the case where the local live entertainment broker 41L is deployed will be described.

First, in step S201, the sensor 21-2 of the client device 20-2 for the viewer 11ME-2 acquires sensor data obtained by observing the target subject and sends the sensor data to the object data server 31-2 of the corresponding server device 30-2.

In step S202, the object data server 31-2 receives the sensor data sent from the sensor 21-2, generates object data based on the sensor data, and stores the object data in an internal storage unit.

In step S203, the object data subscriber 33-2 checks the object data generated by the object data server 31-2 to detect a change in the viewpoint information of the viewer 11ME-2.

In step S204, the object data subscriber 33ME negotiates with the subscription manager 51 of the live entertainment broker 41 for the display level of the object(s) at the viewpoint or within the visible scope, based on the detected viewpoint information of the viewer 11ME-2. As a result of the negotiation, the object data subscription is determined.

In step S205, the subscription manager 51 determines whether all traffic is closed between the object data publisher 32-1 and the object data subscriber 33-2 on one edge cloud. Then, if it is determined that all traffic is closed on one edge cloud, the subscription manager 51 causes the local live entertainment broker 41L to run on that edge cloud to delegate the function of the filter 52 in step S206. Subsequently, in step S207, the subscription manager 51 notifies (announces) the address of the local live entertainment broker 41L to the object data publisher 32-1 on the edge cloud.

On the other hand, in step S211, the sensor 21-1 of the client device 20-1 for the viewer 11ME-1 acquires sensor data obtained by observing the target subject and sends the sensor data to the object data server 31-1 of the corresponding server device 30-1.

In step S212, the object data server 31-1 receives the sensor data sent from the sensor 21-1 and generates object data based on the sensor data.

In step S213, the object data publisher 32-1 checks the object data at a predetermined cycle, and when the update of all the object data is completed, extracts the entire updated object data or only the updated part of the object data, and forwards the extracted object data to the live entertainment broker 41L. When object data in near future is also predicted and generated, that object data is also extracted and forwarded to the local live entertainment broker 41L.

In step S214, a filter 52L of the local live entertainment broker 41L (hereinafter referred to as the local filter 52L) acquires (gets) the object data subscription determined through the negotiation from the subscription manager 51.

In step S215, the local filter 52L performs the filtering based on the filter condition determined by the subscription manager 51. The local filter 52L then sends the filtered object data to the server side renderer 34-2 via the object data subscriber 33-2 for the viewer 11ME-2.

In step S216, the server side renderer 34-2 receives the object data at the viewpoint or within the visible scope, which is sent from the object data subscriber 33-2, generates rendering data, and supplies the rendering data to the display 22-2.

In step S217, the display 22-2 receives and displays the rendering data.

In the case where the rendering processing is executed on the client side, the object data is sent to the client side renderer 23-2 instead of the server side renderer 34-2. The display 22-2 receives the rendering data from the client side renderer 23-2 and displays the received rendering data.

According to the object data forward processing for the local live entertainment broker 41L being deployed, the return of the object data in the edge cloud makes it possible to cover delay requirements and the like and to reduce unwanted traffic in the cloud.

### <10. Variations of Filter Condition>

When the subscription manager 51 of the live entertainment broker 41 determines the object data subscription through negotiation with the object data subscriber 33, the subscription manager 51 forms, from the information described in the object data subscription, filter data 101 for each of the pieces of object data of the artist 11AR and the surrounding audience 11AU. The filter data 101 corresponds to the filter condition described above.

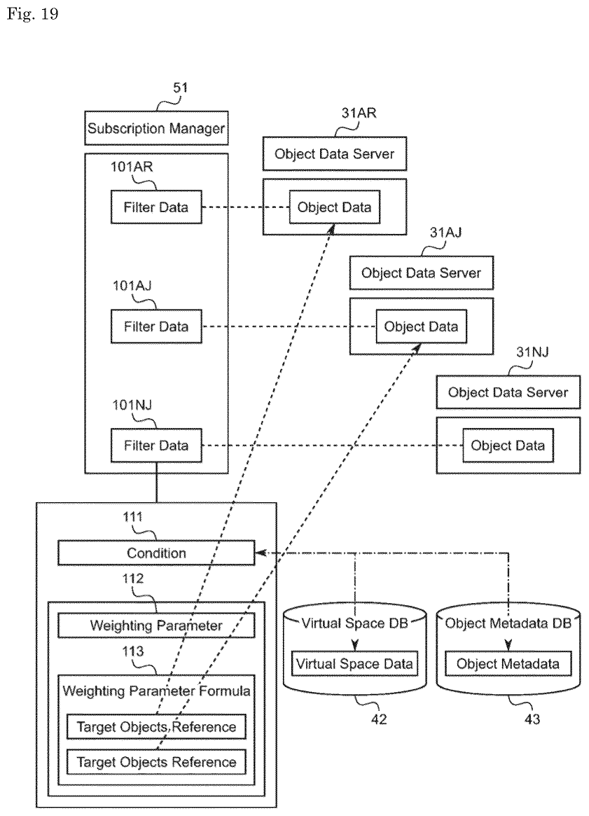

In the example of FIG. 19, filter data 101AR associated with the object data of the artist 11AR, filter data 101AJ associated with the object data of the adjacent audience 11AJ, and filter data 101NJ associated with the object data of the nonadjacent audience 11NJ are generated.

The filter data 101 (101AR, 101AJ, 101NJ) describes a filter condition 111, and also stores a weighting parameter 112 generated from the filter condition 111 and a weighting parameter formula 113. Depending on the details of various conditions described in the filter condition 111, the details of shared state information (for example, the data on the virtual concert venue 12) stored in the virtual space DB 42 and the metadata (object metadata) for each object stored in the object metadata DB 43 may be referred to.

The filter condition 111 for the filter data 101 is described by a combination of the following elements (filter conditions).
Filter conditions related to scopes (visible/audible scopes, etc.) A filter condition related to the visible scope may be a filter condition according to information related to a line-of-sight direction and a visual range. The information related to the visual range may include, for example, a filter condition according to an in-scope level indicating whether it is in the vicinity of the center of the visual range or not.
Filter conditions related to a distance to the target object in the virtual space A weighted degree of attention may be given based on the difference between close objects and distant objects. The distance between objects stored in the virtual space DB 42 is also referred to.
Filter conditions related to the movement of the target object (range, speed, or acceleration) Filter conditions may be given for focusing only on objects with large movements (such as objects whose motion vector length within the visual range or whose velocity or acceleration per unit time is greater than or equal to a predetermined threshold value).
Filter conditions related to the brightness or color of the target object, or the volume of the voice uttered by the target object Filter conditions may be given for focusing only on objects whose luminance, color, volume, and the like are equal to or greater than a threshold value or within a predetermined range.
Filter conditions related to the actions (gestures) of the target object or phrases spoken by the target object Filter conditions may be given for focusing only on an audience 11AU who makes a specific gesture, moves a specific route, or for focusing only on an audience 11AU who says a specific keyword.
Filter conditions related to the degree of interest (level of interest) in the target object

Filter conditions may be given according to, for example, the momentary interest or degree of interest (current and immediate future); the interest or degree of interest based on past personal history; the statistical interest or degree of interest; the degree of interest (tendency) between the artist 11AR and the audience 11AU depending on event type; the tendency of the target of interest according to the event proficiency level (level such as beginner, expert, etc.) of the audience 11AU; and the degree of interest in parts of the target's body, belongings, accessories, or the like.
Filter conditions depending on physical environmental factors with respect to the target object

For example, filter conditions may be given for physical environmental elements such as temperature, humidity, brightness, and amount of dust, depending on the type of virtual space (stadium, hall, etc.).

The filter condition 111 described in the filter data 101 is updated by the object data subscription determined by the object data subscriber 33, and depending on the condition, the information stored in the virtual space DB 42 is also referred to.

For example, the filter condition related to a distance to the target in the virtual space describes a weighting condition that depends on the distance (range) between the objects in the virtual space, and the distance (range) in the virtual space is defined from the positional information of the target object stored in the virtual space DB 42.

In addition, for example, the filter condition that depends on physical environmental elements such as temperature, humidity, brightness, and amount of dust with respect to the target depends on the type of virtual space (shape, layout, material, etc.) stored in the virtual space DB 42, and is defined based on space state information that is updated from time to time.

### <11. Example of Filtering>

Next, filtering (weighting) will be described using an example of filter data 101ME for the viewer 11ME.

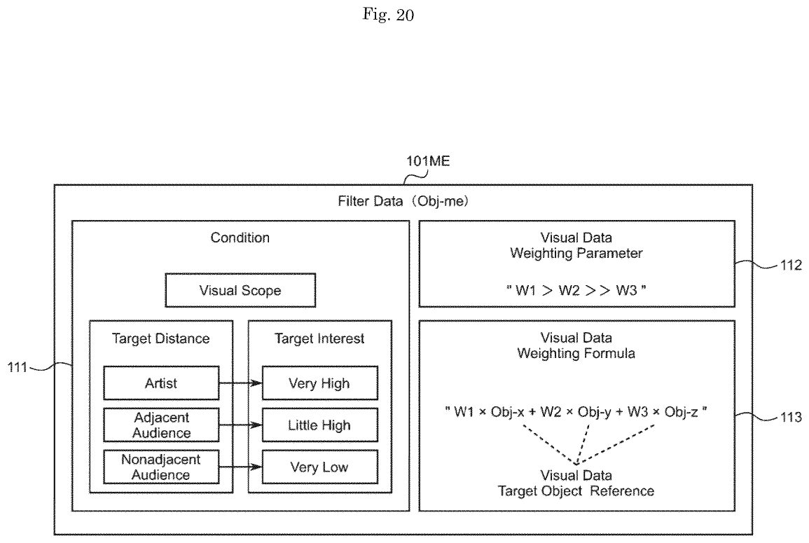

FIG. 20 illustrates an example of the filter data 101ME for the viewer 11ME.

Within the visible scope of the viewer 11ME, there are as target objects the artist 11AR, the adjacent audience 11AJ, and the nonadjacent audience 11NJ. Here, the identifier of the object of the viewer 11ME is “Ojb-me”, and the identifiers of the artist 11AR, the adjacent audience 11AJ, and the nonadjacent audience 11NJ are “Obj-x”, “Obj-y”, and “Obj-z”, respectively.

A method of weighting the object data to be sent from the live entertainment broker 41 to the server side renderer 34 or the client side renderer 23 for the viewer 11ME is described in the filter data 101ME of FIG. 20. The filter data 101ME of FIG. 20 indicates a weighting method for, in particular, making the image quality high or low, such as resolution of video object data (visual object data) among pieces of object data.

The filter condition 111 describe some of the filter conditions described above. “Visible scope” represents a filter condition related to the visible scope. “Target Distance” represents a filter condition related to the distance to the target in the virtual space. “Target Interest” represents a filter condition related to the degree of interest or level of interest in the target. “Target Distance” defines three classifications: artist 11AR, adjacent audience 11AJ, and nonadjacent audience 11NJ. “Target Interest” defines “Very High” for the artist 11AR, “Little High” for the adjacent audience 11AJ, and “Very Low” for the nonadjacent audience 11NJ.

The weighting parameter 112 defines weighting parameters W1, W2, and W3 for the pieces of video object data of the artist 11AR, the adjacent audience 11AJ, and the nonadjacent audience 11NJ, respectively. It is now assumed that the weighting parameters W1, W2, and W3 have a relationship of “W1>W2>>W3”. The weighting parameters W1, W2, and W3 are values calculated from the filter conditions described in the filter condition 111. For example, W1=100%, W2=50%, and W3=10%, and the magnitude relationship among W1 to W3 is reflected in the quality of object data after filtering.

The weighting parameter formula 113 describes the formula “W1×OBJ-x+W2×OBJ-y+W3×OBJ-z”. This formula indicates that Obj-x with the largest weighting value W is processed with the highest mesh density or texture resolution of the video object data, Obj-y with the second largest weighting value W is processed with the second highest mesh density or texture resolution of the video object data, and Obj-z with the third largest weighting value W is processed with the third highest mesh density or texture resolution of the video object data. More specifically, the formula indicates that the mesh density or texture resolution for the video object data of the artist 11AR with W1=100% remains unchanged, the mesh density or texture resolution for the video object data of the adjacent audience 11AJ with W2=50% is reduced by half, and the mesh density or texture resolution for the video object data of the nonadjacent audience 11NJ with W3=10% is reduced to 1/10. Examples of the processing for reducing the texture resolution include processing for reducing the spatial resolution, processing for reducing the temporal resolution, and processing for reducing the bit depth.

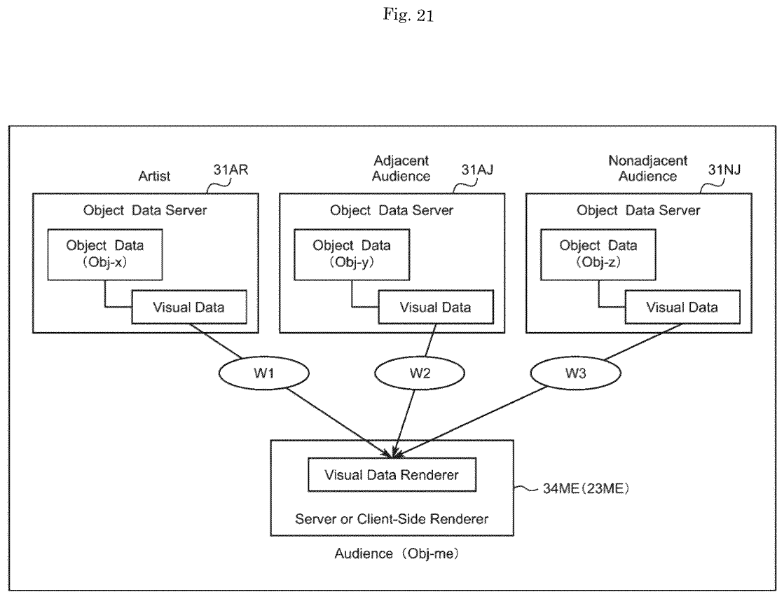

The filtering processing for the video object data in the formula described in the weighting parameter formula 113 in FIG. 20 is conceptually illustrated in FIG. 21 in view of the relationship among the object data servers 31 (31AR, 31AJ, 31NJ) for the artist 11AR, the adjacent audience 11AJ, and the nonadjacent audience 11NJ, and the server side renderer 34ME (or the client side renderer 23ME) for the viewer 11ME.

The filtering processing load of the filter 52 of the live entertainment broker 41 possibly becomes extremely high, that is, it may be expected that the processing load of reducing the mesh density or texture resolution of the video object data becomes high, and therefore the delay caused by the filtering processing becomes extremely high. In such a case, in generating object data based on sensor data, each object data server 31 may generate in advance object data whose resolution is reduced by a plurality of levels. In that case, the weighting value W is also adjusted to match the levels.

### <12. Subdivision Setting Example of Weighting Parameters>

It is also possible to set a different value of weighting parameter W for each portion of interest even among the same type of pieces of object data. For example, an example will be described in which a different value of weighting parameter W is set depending on a difference in the interest or degree of interest of the viewer 11ME, for the movements of the target object that are divided into pen light movement, and face/body movement.

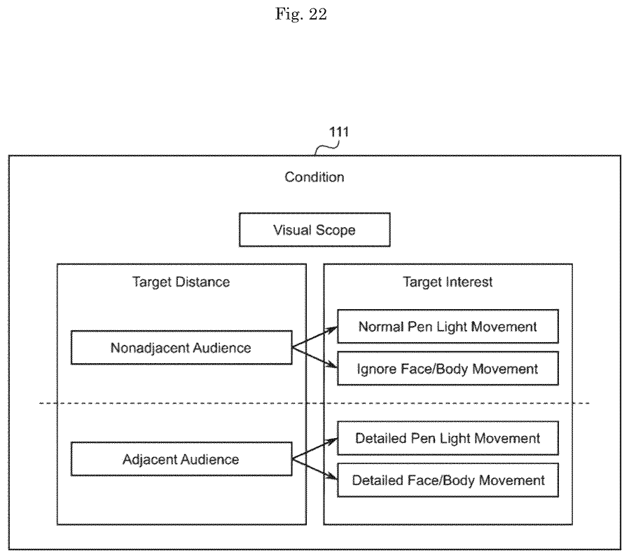

FIG. 22 illustrates another example of the filter condition 111 for the filter data 101ME for the viewer 11ME.

The filter condition 111 of FIG. 22 describes “Visible Scope”, which represents a filter condition related to the, “Target Distance”, which represents a filter condition related to the distance to the target object in the virtual space, and “Target Interest”, which represents a filter condition related to the degree of interest or level of interest in the target object.

“Target Distance” defines two classifications: adjacent audience 11AJ and nonadjacent audience 11NJ.

In “Target Interest”, a filter condition is set for each of the adjacent audience 11AJ and the nonadjacent audience 11NJ, depending on a difference in the interest or degree of interest of the viewer 11ME, for the movements of the target object that are divided into pen light movement, and face/body movement. It is now assumed that for the nonadjacent audience 11NJ, the viewer 11ME is interested in the audience's pen light movement (“Normal”) but not interested in the audience's face/body movement (“Ignore”); for the adjacent audience 11AJ, the viewer 11ME is very interested in both the audience's pen light movement and the audience's face/body movement (“Detailed”).

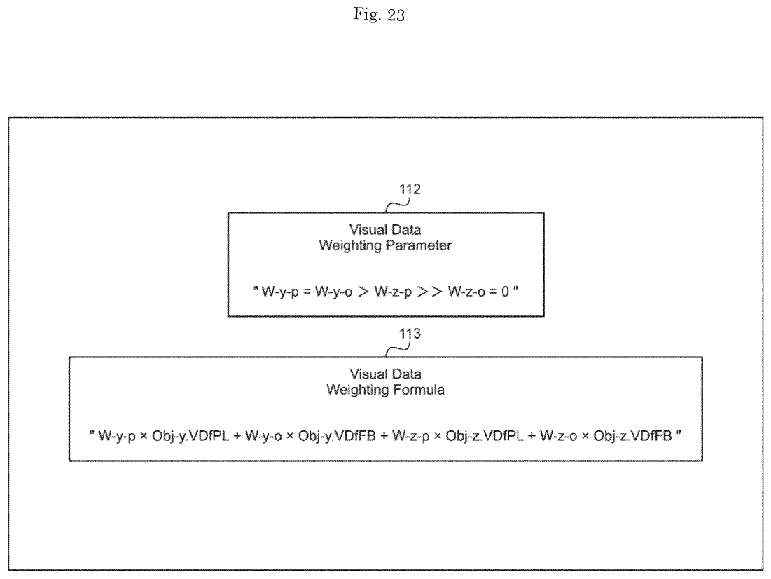

FIG. 23 illustrates the weighting parameter 112 and the weighting parameter formula 113 for the filter data 101ME for the viewer 11ME corresponding to the filter condition 111 of FIG. 22.

The video object data of each of the adjacent audience 11AJ and the nonadjacent audience 11NJ is composed of the video object data for the pen light “Visual Object Data For Pen Light” and the video object data for the face/body “Visual Object Data For Face/Body”. The identifier of the video object data for the pen light “Visual Object Data For Pen Light” is “VDfPL”, and the identifier of the video object data for the face/body “Visual Object Data For Face/Body” is “VDfFB”.

Since the identifier of the adjacent audience 11AJ is “Obj-y”, the identifier of the video object data for the pen light of the adjacent audience 11AJ is “Obj-y.VDfPL”, and the identifier of the video object data for the face/body of the adjacent audience 11AJ “Visual Object Data For Face/Body” is “Obj-y.VDfFB”. Since the identifier of the nonadjacent audience 11NJ is “Obj-z”, the identifier of the video object data for the pen light of the nonadjacent audience 11NJ is “Obj-z.VDfPL”, and the identifier of the video object data for the face/body of the nonadjacent audience 11NJ “Visual Object Data For Face/Body” is “Obj-z.VDfFB”.

The weighting parameter 112 defines weighting parameters W-y-p, W-y-o, W-z-p, and W-z-o for: the pieces of video object data for the pen light and the pieces of video object data for the face/body of the adjacent audience 11AJ and the nonadjacent audience 11NJ, respectively.

The weighting parameter W-y-p represents a weight for the video object data for the pen light of the adjacent audience 11AJ. The weighting parameter W-y-o represents a weight for the video object data for the face/body of the adjacent audience 11AJ. The weighting parameter W-z-p represents a weight for the video object data for the pen light of the nonadjacent audience 11NJ. The weighting parameter W-z-o represents a weight for the video object data for the face/body of the nonadjacent audience 11NJ. It is now assumed that the weighting parameters W-y-p, W-y-o, W-z-p, and W-z-o have a relationship of “W-y-p=W-y-o>W-z-p>>W-z-o=0”, for example, W-y-p=W-y-o=100%, W-z-p=50%, and W-z-o=0%.

The weighting parameter formula 113 describes the formula “W-y-p×Obj-y.VDfPL+W-y-o×Obj-y.VDfFB+W-z-p×Obj-z.VDfPL+W-z-o×Obj-z.VDfFB”. This formula indicates that the video object data (Obj-y.VDfPL) for the pen light of the adjacent audience 11AJ and the video object data (Obj-y.VDfFB) for the face/body of the adjacent audience 11AJ, which are with the largest weighting value W, are processed with the highest, mesh density or texture resolution (100%). The formula also indicates that the video object data (Obj-z.VDfPL) for the pen light of the nonadjacent audience 11NJ with the second largest weighting value W is processed with the second highest mesh density or texture resolution (50%), and the video object data (Obj-z.VDfFB) for the face/body of the nonadjacent audience 11NJ with the third largest weighting value W is processed with the third highest mesh density or texture resolution (0%).

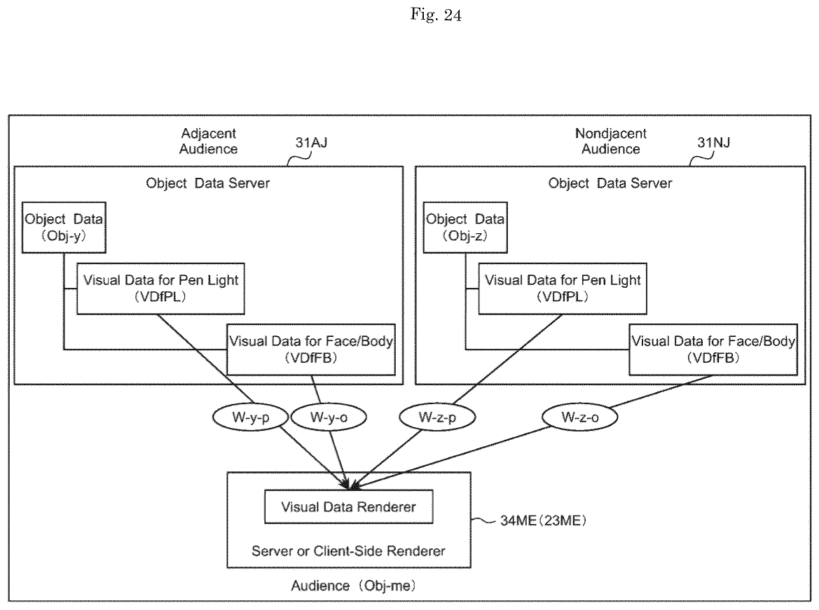

The filtering processing for the video object data in the formula described in the weighting parameter formula 113 in FIG. 23 is conceptually illustrated in FIG. 24 in view of the relationship among the object data servers 31 (31AJ, 31NJ) for the adjacent audience 11AJ and the nonadjacent audience 11NJ, and the server side renderer 34ME (or the client side renderer 23ME) for the viewer 11ME.

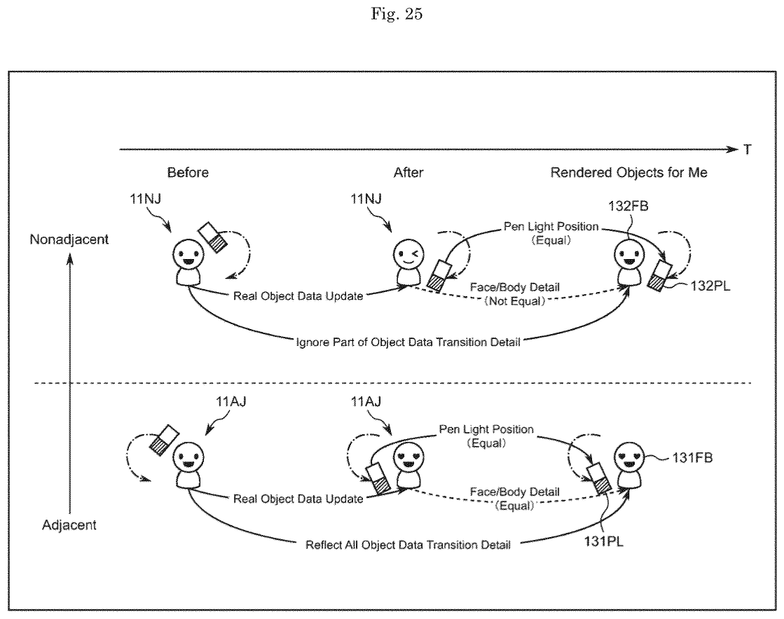

FIG. 25 is a diagram illustrating a difference between the adjacent audience 11AJ and the nonadjacent audience 11NJ that are displayed on the display 22ME for the viewer 11ME by the filtering processing for the video object data in the formula described in the weighting parameter formula 113 of FIG. 23.

In FIG. 25, the “Before” adjacent audience 11AJ and nonadjacent audience 11NJ are the adjacent audience 11AJ and the nonadjacent audience 11NJ before the update of the object data to be filtered.

The “After” adjacent audience 11AJ and nonadjacent audience 11NJ are the adjacent audience 11AJ and the nonadjacent audience 11NJ after the update of the object data to be filtered.

Object data is generated based on the sensor data obtained by the sensor 21 for the Before adjacent audience 11AJ and nonadjacent audience 11NJ, and stored in the object data server 31. At the time when the object data of the After adjacent audience 11AJ and nonadjacent audience 11NJ are updated, the object data publisher 32 extracts the object data and forwards the updated object data to the live entertainment broker 41.

The filter 52 of the live entertainment broker 41 executes the filtering processing for the video object data in the formula described in the weighting parameter formula 113 of FIG. 23. The filtered object data is sent to the server side renderer 34ME (or the client side renderer 23ME) via the object data subscriber 33ME for the viewer 11ME, rendered there, and then displayed on the display 22ME for the viewer 11ME.

A face/body video 131FB and a pen light video 131PL of the adjacent audience 11AJ illustrated in “Rendered Objects For Me” in FIG. 25 are displayed on the display 22ME. In addition, a face/body video 132FB and a pen light video 132PL of the nonadjacent audience 11NJ illustrated in “Rendered Objects For Me” in FIG. 25 are displayed on the display 22ME for the viewer 11ME.

For the face/body video 131FB and the pen light video 131PL of the adjacent audience 11AJ, both the pen light movement and the face movement (facial expression) in the object data is updated and rendered in detail. In other words, these videos match those of the face/body and the pen light of the After adjacent audience 11AJ.

On the other hand, for the face/body video 132FB and the pen light video 132PL of the nonadjacent audience 11NJ, the movement of the pen light is rendered relatively accurately. However, this video has half of information compared with the pen light movement of the adjacent audience 11AJ. In contrast, the face movement is ignored. In other words, the face/body video 132FB of the nonadjacent audience 11NJ is not the After facial expression, but the Before facial expression of the nonadjacent audience 11NJ.

### <13. Filtering Processing of Local Live Entertainment Broker>

Also in the case where the local live entertainment broker 41L is deployed on the edge cloud, the filtering processing can be executed in the same way.

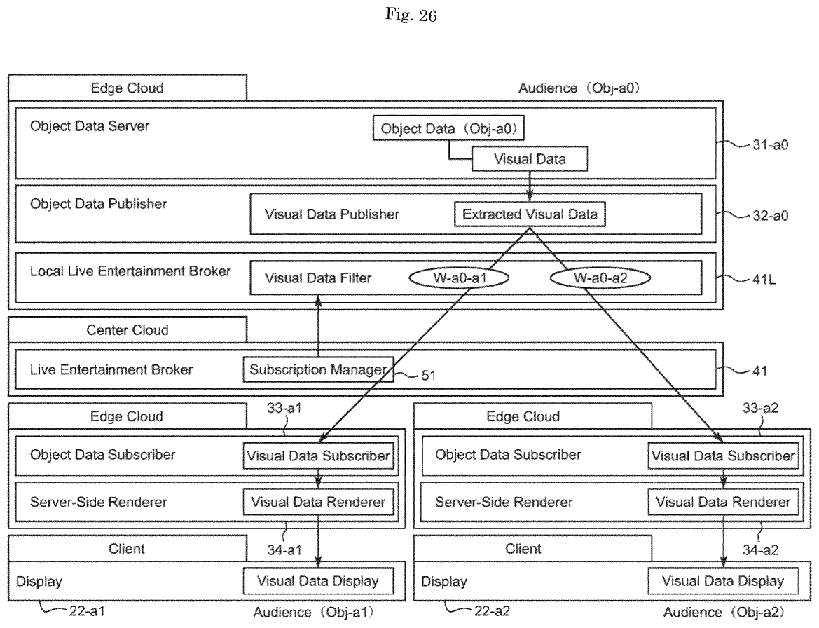

FIG. 26 illustrates the flow of filtering the video object data of an adjacent audience 11AJ-a0 and forwarding the filtered video object data to viewers 11ME-a1 and 11ME-a2.

A case will now be described in which the adjacent audience 11AJ-a0 is present within both the visible scopes of the viewer 11ME-a1 and the viewer 11ME-a2, and the object data subscriber 33 for the viewer 11ME-a1, the object data subscriber 33 for the viewer 11ME-a2, and the object data publisher 32 for the adjacent audience 11AJ-a0 are deployed on different edge clouds.

The local live entertainment broker 41L is deployed on the same edge cloud as an object data server 31-a0 and an object data publisher 32-a0 for the adjacent audience 11AJ-a0.

A weighting parameter W-a0-a1 is a weight for the video object data (Obj-a0) of the adjacent audience 11AJ-a0 as viewed from the viewer 11ME-a1. A weighting parameter W-a0-a2 is a weight for the video object data (Obj-a0) of the adjacent audience 11AJ-a0 as viewed from the viewer 11ME-a2.

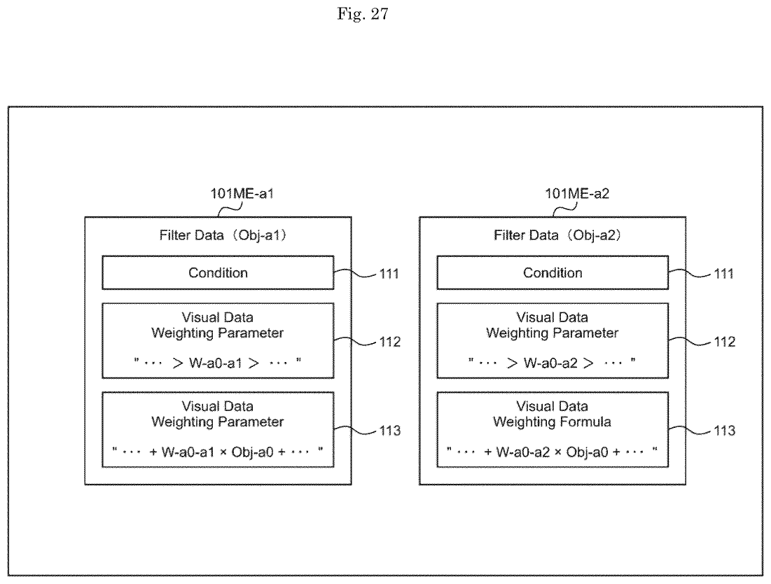

FIG. 27 illustrates an example of filter data 101ME-a1 for the viewer 11ME-a1 and filter data 101ME-a2 for the viewer 11ME-a2.

The weighting parameter formula 113 for the filter data 101ME-a1 describes the formula “+W-a0-a1×Obj-a0+”.

The weighting parameter formula 113 for the filter data 101ME-a2 describes the formula “+W-a0-a2×Obj-a0+”.

Returning to FIG. 26, the local live entertainment broker 41L performs filtering processing corresponding to the weighting parameter W-a0-a1 on the video object data (Obj-a0) of the adjacent audience 11AJ-a0, and sends the resulting data to an object data subscriber 33-a1 for the viewer 11ME-a1 on a different edge server.

The local live entertainment broker 41L performs filtering processing corresponding to the weighting parameter W-a0-a2 on the video object data (Obj-a0) of the adjacent audience 11AJ-a0, and sends the resulting data to an object data subscriber 33-a2 for the viewer 11ME-a2 on a different edge server.

The object data subscriber 33-a1 for the viewer 11ME-a1 receives the object data and supplies the received object data to a server side renderer 34-a1. The server side renderer 34-a1 receives the object data at the viewpoint or within the visible scope, which is sent from the object data subscriber 33-a1, generates rendering data, and supplies the rendering data to a display 22-a1.

The object data subscriber 33-a2 for the viewer 11ME-a2 receives the object data and supplies the received object data to a server side renderer 34-a2. The server side renderer 34-a2 receives the object data at the viewpoint or within the visible scope, which is sent from the object data subscriber 33-a2, generates rendering data, and supplies the rendering data to a display 22-a2.

As described above, the local live entertainment broker 41L is deployed in a distributed manner on the same edge cloud as the object data server 31-a0 and the object data publisher 32-a0 for the adjacent audience 11AJ-a0, which generate object data to be filtered, and performs the filtering processing there.

By implementing the filtering function near the object data publisher 32-a0 that publishes the object data to be filtered, the traffic within the cloud (between the edge cloud and the center cloud) can be reduced. Thus, it is possible to reduce the traffic in the cloud compared to the case where the filtering processing is executed by the live entertainment broker 41 on the center cloud.

### <14. Block Diagram of Functional Components>

Each functional component of the data processing system 1 will be described below.

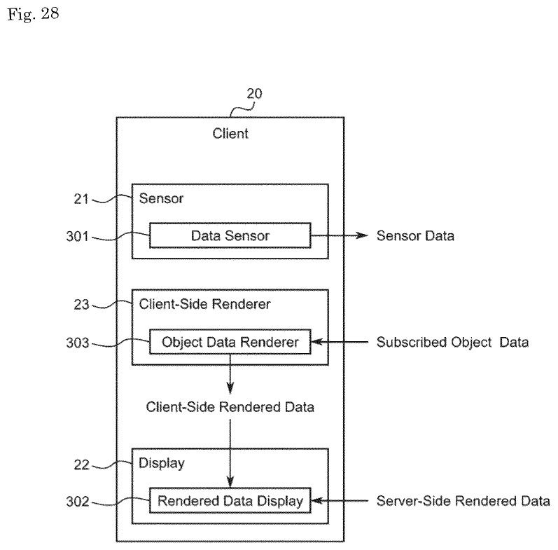

FIG. 28 is a block diagram illustrating a functional configuration example of the client device 20.

The client device 20 may include the sensor 21, the display 22, and the client side renderer 23 as functional components.

The sensor 21 generates sensor data of the target subject and sends the generated sensor data from a data sensor 301 to the object data server 31.

When the rendering processing is executed on the server side, the display 22 acquires the rendered rendering data from the server side renderer 34 and displays the rendering data on a rendered data display 302. On the other hand, when the rendering processing is executed on the client side, the display 22 acquires the rendering data from the client side renderer 23 and displays the rendering data on the rendered data display 302.

The client side renderer 23 receives the object data at the viewpoint or within the visible scope, which is sent from the object data subscriber 33, generates rendering data in an object data renderer 303, and supplies the rendering data to the display 22.

The rendering data forwarded from the server side renderer 34 is encoded by a predetermined compression and encoding method suitable for stream immediately before being forwarded, and forwarded as an encoded stream. The object data sent from the object data subscriber 33 is also encoded by a predetermined compression and encoding method suitable for stream, and forwarded as an encoded stream. The same applies to the case where the sensor data and the object data are exchanged between the functional components.

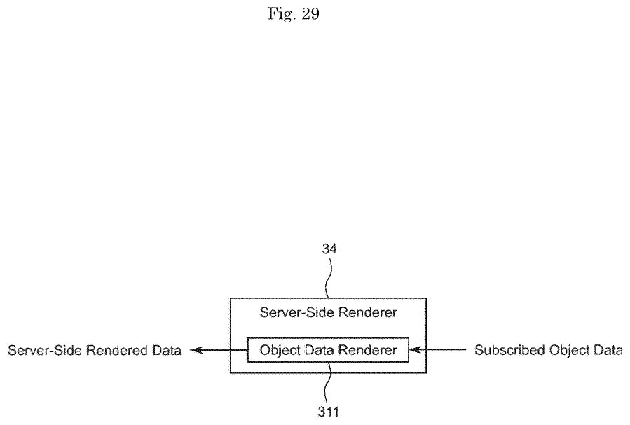

FIG. 29 is a block diagram illustrating a functional configuration of the server side renderer 34.

The server side renderer 34 renders the object data at the viewpoint or within the visible scope, which is supplied from the object data subscriber 33, in an object data renderer 311 to generate rendering data. The server side renderer 34 encodes the generated rendering data using a predetermined compression and encoding method, and sends the encoded stream data to the display 22 of the client device 20.

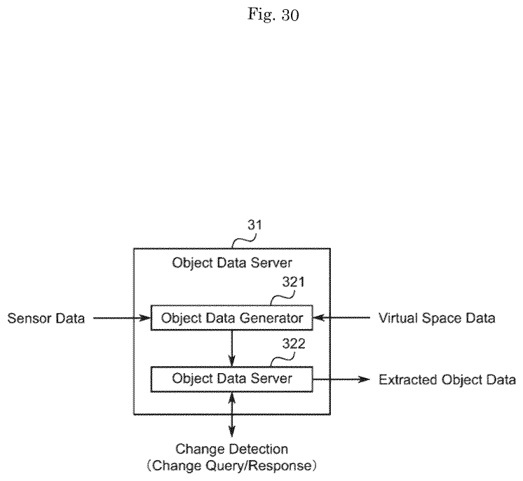

FIG. 30 is a block diagram illustrating a functional configuration of the object data server 31.

The object data server 31 includes an object data generator 321 and an object data server 322.

The object data generator 321 generates object data from sensor data sent from the sensor 21 of the client device 20, and stores the object data in the object data server 322, which is an internal storage unit. The object data generator 321 refers to state information (Virtual Space Data) shared by the objects stored in the virtual space DB 42 as appropriate when generating object data.

The object data server 322 stores the object data from the object data generator 321. The object data server 322 also responds to a result of checking for a change in the object data from the object data subscriber 33 by queries and responses. For example, when the object data server 322 detects a change in the object data corresponding to a change in the viewpoint information, the object data server 322 notifies the object data subscriber 33 of that change.

The object data server 322 also extracts the entire updated object data or only the updated part of the object data in response to an object data extraction request from the object data publisher 32, and supplies the extracted object data to the object data publisher 32.

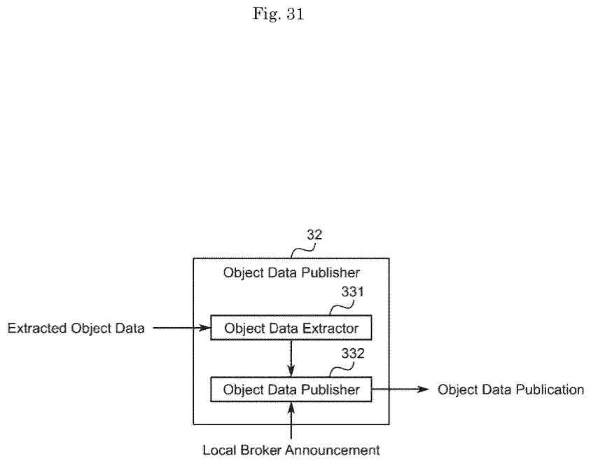

FIG. 31 is a block diagram illustrating a functional configuration of the object data publisher 32.

The object data publisher 32 includes an object data extractor 331 and an object data publisher 332.

The object data extractor 331 sends an object data extraction request to the object data server 322, and acquires the entire updated object data or only the updated part of the object data, which is sent in response to the extraction request. The object data extractor 331 supplies the acquired object data to the object data publisher 332.

The object data publisher 332 stores the object data acquired from the object data extractor 331 in the object data publication structure and forwards the object data to the live entertainment broker 41. In the case where the local live entertainment broker 41L is deployed, the object data with the object data publication structure is forwarded to the local live entertainment broker 41L.

When the local live entertainment broker 41L is activated, the object data publisher 332 acquires a notification of the local live entertainment broker 41L from the subscription manager 51. The notification of the local live entertainment broker 41L includes, for example, the address of the local live entertainment broker 41L to be notified. This allows the object data publisher 332 to recognize that the function of the filter 52 has been delegated to the local live entertainment broker 41L.

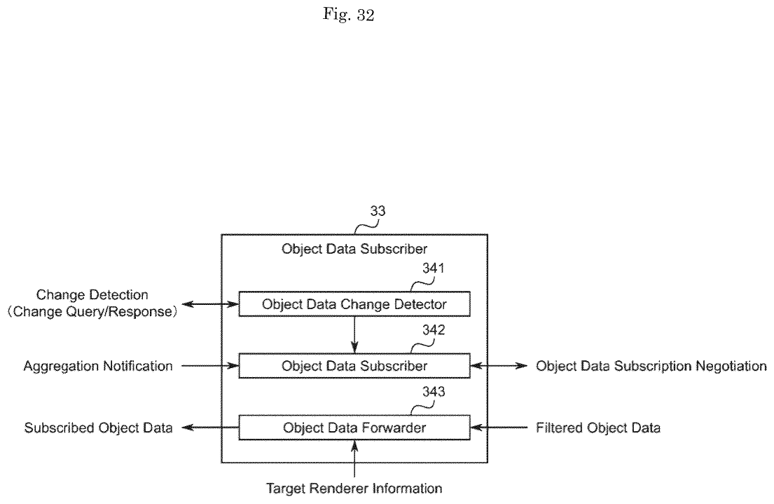

FIG. 32 is a block diagram illustrating a functional configuration of the object data subscriber 33.

The object data subscriber 33 includes an object data change detector 341, an object data subscriber 342, and an object data forwarder 343.

The object data change detector 341 checks for a change in the object data by queries and responses between the object data change detector 341 and the object data server 31. When the object data change detector 341 detects a change in the object data such as a change in the viewpoint information of the target subject, the object data change detector 341 notifies the object data subscriber 342 of that detection.

When a change in the object data is detected, the object data subscriber 342 negotiates with the subscription manager 51 of the live entertainment broker 41. As a result of the negotiation, the object data subscription is determined.

When common rendering data is to be made, the object data subscriber 342 acquires a notification of the common rendering data from the edge resource orchestrator 35. When receiving no object data, the object data subscriber 342 stops the processing of the object data forwarder 343.

The object data forwarder 343 is notified of a renderer (target renderer) to which the object data is to be forwarded, from the edge resource orchestrator 35. The target renderer is either the server side renderer 34 or the client side renderer 23. The target renderer to be notified as, for example, the address of the renderer to which the object data is to be forwarded.

The object data forwarder 343 receives the object data at the viewpoint or within the visible scope, which is sent from the live entertainment broker 41, and forwards (sends) the object data to the target renderer. The object data sent from the live entertainment broker 41 is data filtered based on the determined object data subscription.

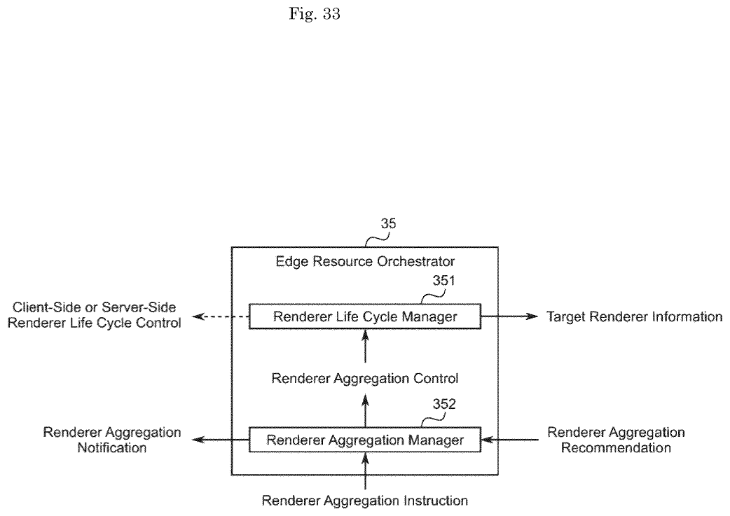

FIG. 33 is a block diagram illustrating a functional configuration of the edge resource orchestrator 35.

The edge resource orchestrator 35 includes a renderer life cycle manager 351 and a renderer aggregation manager 352.

The renderer life cycle manager 351 determines whether the rendering is to be executed on the server side or the client side according to the status of load of computing resources and storage resources of the edge cloud, the status of traffic between the client device 20 and the edge cloud, and the like. The renderer life cycle manager 351 then causes the renderer to run at the determined execution place. Specifically, if it is determined to execute the rendering on the server side, the renderer life cycle manager 351 causes the server side renderer 34 to run, and if it is determined to execute the rendering on the client side, the renderer life cycle manager 351 causes the client side renderer 23 of the client device 20 to run. The renderer life cycle manager 351 supplies information on the renderer (target renderer) caused to run to the object data forwarder 343 of the object data subscriber 33.

The renderer aggregation manager 352 monitors the status of overall traffic in the edge cloud, the status of traffic between the renderer aggregation manager 352 and the client device 20 under its control, and the status of load in the edge cloud. When the renderer aggregation manager 352 determines as a result of monitoring that the load in the edge cloud is high, the renderer aggregation manager 352 recommends that the rendering processing commonization on the edge cloud is to be executed to the filter 52 of the live entertainment broker 41.

When the renderer aggregation manager 352 receives a notification to make common rendering data from the live entertainment broker 41 in response to the recommendation that the rendering processing commonization is to be executed, the renderer aggregation manager 352 sends a notification of the common rendering data to the object data subscriber 342 (FIG. 32).

When common rendering data is made, the renderer aggregation manager 352 also supplies a notification of the common rendering data to the renderer life cycle manager 351. As a result, for example, the renderer life cycle manager 351 causes one server side renderer 34 that aggregately processes the rendering data for a plurality of client devices 20 to run on the edge cloud.

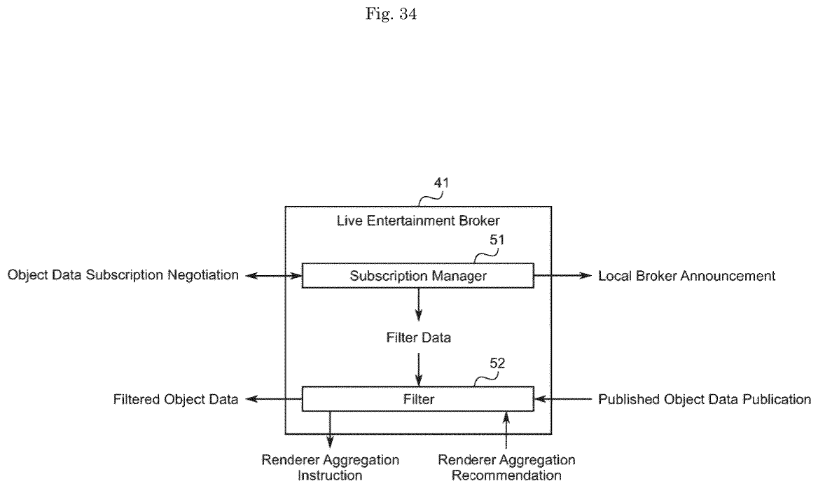

FIG. 34 is a block diagram illustrating a functional configuration of the live entertainment broker 41.

The live entertainment broker 41 includes a subscription manager 51 and a filter 52.

The subscription manager 51 performs negotiations with the object data subscriber 342 (FIG. 32) to determine an object data subscription. The subscription manager 51 provides filter data based on the object data subscription to the filter 52. This filter data corresponds to, for example, the filter data 101ME illustrated in FIG. 20.

The subscription manager 51 determines whether all traffic is closed between the object data publisher 32 and the object data subscriber 33 on one edge cloud. Then, if it is determined that all traffic is closed on one edge cloud, the subscription manager 51 causes the local live entertainment broker 41L to run on that edge cloud to delegate the function of the filter 52. Even if it is determined that all traffic is not closed on one edge cloud, the subscription manager 51 may be configured to also cause the local live entertainment broker 41L to run on that edge cloud to delegate the function of the filter 52. The subscription manager 51 notifies the address of the local live entertainment broker 41L to the object data publisher 32 on the edge cloud.

The filter 52 acquires the filter data based on the object data subscription from the subscription manager 51. The filter 52 also acquires the object data stored in the object data publication structure from the object data publisher 32.

The filter 52 filters the object data based on the filter condition 111 (FIG. 20) described in the filter data. The filter 52 then sends the filtered object data to the object data subscriber 33.

Furthermore, when the filter 52 receives a recommendation that the rendering processing commonization on the edge cloud is to be executed from the renderer aggregation manager 352, the filter 52 determines whether the details of the object data subscriptions may be substantially the same based on the filter condition 111 for the filter data. If the details of the object data subscriptions may be substantially the same, the filter 52 notifies (instructs) the renderer aggregation manager 352 to make common rendering data.

### <15. Configuration Example of Cloud Computing>

The methods and systems described herein, including the data processing system 1 described above and the network control method thereof, are implemented using computer software, firmware, hardware, or computer programming or engineering techniques including combinations or subsets thereof.

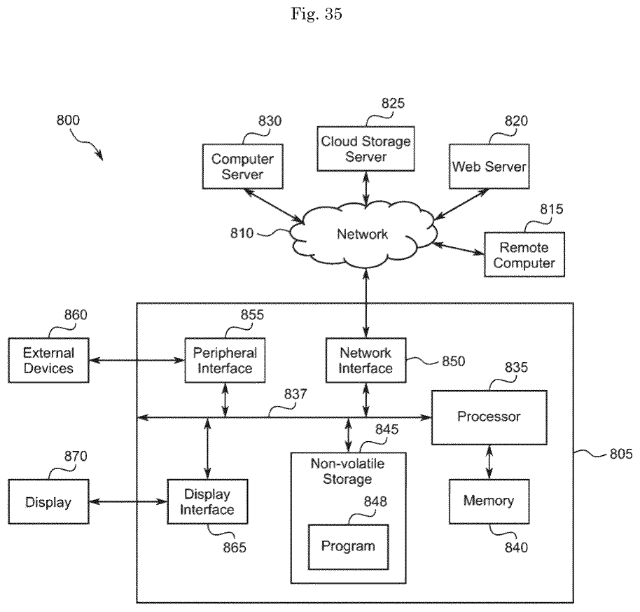

FIG. 35 illustrates a block diagram of a computer on which various embodiments described herein can be implemented.

The present disclosure can be implemented as a system, a method and/or a computer program. The computer program may include a computer-readable storage medium on which computer-readable program instructions are recorded that cause one or more processors to execute the aspects of embodiments.

The computer-readable storage medium may be a physical device that can store instructions for use in an instruction-executable device (processor). Examples of the computer-readable storage medium include, but not limited to, an electronic storage device, a magnetic storage device, an optical storage device, an electromagnetic storage device, a semiconductor storage device, and any suitable combination thereof. More specific examples of the computer-readable storage medium include each (and any suitable combination) of; a floppy disk, a hard disk, a solid state drive (SSD), a random access memory (RAM), a read memory (ROM), an erasable and programmable read only memory (EPROM) or a flash memory (Flash), a static random access memory (SRAM), a compact disc (CD or CD-ROM), a digital versatile disc (DVD), and card or stick memory. The computer-readable storage medium as used in the present disclosure should not be interpreted as transitory signals, such as radio waves or other freely propagating electromagnetic waves; electromagnetic waves propagating through waveguides or other transmission media (for example, light pulses through fiber optic cables); and electrical signals transmitted via wires.

The computer-readable program instructions according to the present disclosure may be downloaded from a computer-readable storage medium to a suitable computing or processing device or to an external computer or external storage device, for example, via a global network such as the Internet, a local area network, a wide area network, and/or a wireless network. Such a network may include copper transmission lines, optical fibers, wireless transmission, routers, firewalls, switches, gateway computers, and/or edge servers. A network adapter card or a network interface, included in the computing device or the processing device, may receive computer-readable program instructions from the network, and forward the computer-readable program instructions to a computer-readable storage medium included in the computing device or the processing device, on which the computer-readable program instructions are stored.

The computer-readable program instructions to execute the processing according to the present disclosure include machine language instructions and/or microcode, which are compiled or interpreted from source codes written in any combination of one or more programming languages including assembly language, Basic, Fortran, Java, Python, R, C, C++, C# and similar programming languages. The computer-readable program instructions may be executed entirely on the user's personal computer, notebook computer, tablet, or smart phone, and may be executed perfectly even on a remote computer or computer server, or any combination of such computing devices. The remote computer or computer server may be connected to a user's device or a device connected via a computer network such as a local area network, a wide area network, a global network (for example, the Internet). To implement the aspects of the present disclosure, there may be provided an embodiment in which electrical circuitry, including, for example, programmable logic circuits, field-programmable gate arrays (FPGAs), and programmable logic arrays (PLAs), can use information from computer-readable program instructions that configure or customize electronic circuits to execute the computer-readable program instructions.

The aspects of the present disclosure are described herein with reference to the flowcharts and block diagrams of the method, device (system), and computer program according to the embodiments of the present disclosure. It will be understood by those of ordinary skill in the art that each block of the flowcharts and block diagrams, and combinations of blocks in the flowcharts and block diagrams can be implemented by the computer-readable program instructions.

The computer-readable program instructions that can execute the systems and methods described in the present disclosure may be used by one or more processors (and/or one or more cores within a processor) of a general purpose computer, a special purpose computer, or other programmable device for manufacturing a device. Execution of the program instructions through the processor of a computer or other programmable device creates the system(s) for implementing the functions described in the flow diagrams and block diagrams of the present disclosure. Such computer-readable program instructions may also be stored on a computer-readable storage medium that can instruct a computer, a programmable device, and/or other device to function in a particular manner. Accordingly, the computer-readable storage medium having the instructions stored thereon is a product containing instructions that implement aspects of the functionality identified in the flowcharts and block diagrams of the present disclosure.

The computer-readable program instructions are also loaded into a computer, other programmable device, or other device to execute a sequence of operational steps on the computer, other programmable device, or other device, and produce processing results of the computer. The program instructions are executed on the computer, other programmable device, or other device to implement the functions identified in the flowcharts and block diagrams of the present disclosure.

FIG. 35 is a functional block diagram of a network system 800 in which one or more computers, servers, and the like are connected via a network. The hardware and software environment illustrated in the embodiment of FIG. 35 is illustrated as an example that provides a platform for implementing the software and/or method according to the present disclosure.

As illustrated in FIG. 35, the network system 800 includes, but not limited to, a computer 805, a network 810, a remote computer 815, a web server 820, a cloud storage server 825, and a computer server 830. In a certain embodiment, a plurality of instances of one or more of the functional blocks illustrated in FIG. 35 are used.

In FIG. 35, a more detailed configuration of the computer 805 is illustrated. The functional blocks illustrated in the computer 805 are illustrated to establish exemplary functionality, which are not exhaustive. Further, although the detailed components of the remote computer 815, the web server 820, the cloud storage server 825, and the computer server 830 are not illustrated, they may include the same components as the functional blocks illustrated in the computer 805.

The computer 805 may be a personal computer (PC), a desktop computer, a laptop computer, a tablet computer, a netbook computer, a personal digital assistant (PDA), a smartphone, or any other programmable electronic device capable of communicating with other devices on the network 810.

The computer 805 is configured to include a processor 835, a bus 837, a memory 840, a non-volatile storage 845, a network interface 850, a peripheral interface 855, and a display interface 865. In some embodiments, each of these functions may be implemented in an individual electronic subsystem (an integrated circuit chip or a combination of chips and related devices), and in other embodiments, some of the functions may be combined and mounted on a single chip (System on Chip (SoC)).

The processor 835 can be, for example, one or more single- or multi-chip microprocessors such as those designed and/or manufactured by Intel Corporation, Advanced Micro Devices, Inc. (AMD), Arm Holdings (Arm), and Apple Computer. Examples of the microprocessors include Celeron, Pentium, Core i3, Core i5, and Core i7 from Intel Corporation, Opteron, Phenom, Athlon, Turion, and Ryzen from AMD, and Cortex-A, Cortex-R, and Cortex-M from Arm.

The bus 837 can employ a variety of proprietary or industry standard high-speed parallel or serial peripheral interconnect buses for ISA, PCI, PCI Express (PCI-e), AGP, and the like, for example.

The memory 840 and the non-volatile storage 845 are computer-readable storage media. The memory 840 can employ any suitable volatile storage device such as a dynamic random access memory (DRAM) or a static RAM (SRAM). The non-volatile storage 845 can employ at least one or more of a flexible disk, a hard disk, a solid state drive (SSD), a read only memory (ROM), an erasable and programmable read only memory (EPROM), a flash memory, a compact disk (CD or CD-ROM), and a digital versatile disc (DVD), a card memory, and a stick memory.

The program 848 is a set of machine-readable instructions and/or data. This set is stored in the non-volatile storage 845 and is used to create, manage, and control specific software functions described in detail in the present disclosure and illustrated in the drawings. In a configuration in which the memory 840 is much faster than the non-volatile storage 845, the program 848 can be transferred from the non-volatile storage 845 to the memory 840 before being executed by the processor 835.

The computer 805 can communicate and interact with other computers over network 810 via network interface 850. The network 810 may adopt, for example, a configuration including a wired, wireless, or optical fiber connection using a local area network (LAN), a wide area network (WAN) such as the Internet, or a combination of LAN and WAN. In general, the network 810 is composed of any combination of connections and protocols that support communication between two or more computers and related devices.

The peripheral interface 855 allows for input and output of data with other devices that may be locally connected to the computer 805. For example, the peripheral interface 855 provides connectivity to external devices 860. The external devices 860 to be used include a keyboard, a mouse, a keypad, a touch screen, and/or other suitable input device. The external devices 860 may also include a portable computer-readable storage medium such as, for example, a thumb drive, a portable optical or magnetic disk, and a memory card. The software and data for implementing the embodiments of the present disclosure, for example, the program 848 may be stored on such a portable computer-readable storage medium. In such embodiments, the software may be loaded into the non-volatile storage 845 or, alternatively, loaded directly into the memory 840 via the peripheral interface 855. The peripheral interface 855 may use industry standards such as RS-232 or Universal Serial Bus (USB) to connect to the external devices 860.

The display interface 865 allows the computer 805 to connect a display 870, and in some forms, the display 870 may be used to present a command line or a graphical user interface to a user of the computer 805. The display interface 865 can use one or more of industry standards, such as Video Graphics Array (VGA), Digital Visual Interface (DVI), DisplayPort, and High-Definition Multimedia Interface (HDMI), or proprietary connections to allow for connection to the display 870.

As described above, the network interface 850 provides communication with other computers, storage systems, or devices external to the computer 805. The software programs and data described herein can be downloaded from, for example, the remote computer 815, the web server 820, the cloud storage server 825, and the computer server 830 to the non-volatile storage 845 via the network interface 850 and the network 810. In addition, the systems and methods according to the present disclosure can be executed by one or more computers connected to the computer 805 via the network interface 850 and the network 810. For example, in a certain embodiment, the systems and methods according to the present disclosure are executed by the remote computer 815, the computer server 830, or a combination of interconnected computers on the network 810.

Data, datasets and/or databases to be employed in the embodiments of the systems and methods according to the present disclosure may be downloaded from the remote computer 815, the web server 820, the cloud storage server 825, and the computer server 830, and stored.

The processing executed by the computer in accordance with the program described herein may not necessarily be executed chronologically in the order described as the flowcharts. In other words, the processing executed by the computer in accordance with the program also includes processing that is executed in parallel or individually (for example, parallel processing or processing by objects).

The program may be processed by a single computer (processor) or may be processed by a plurality of computers in a distributed manner. Furthermore, the program may be sent to a remote computer to be executed.

Moreover, a system as used herein means a collection of a plurality of constituent elements (including devices and modules (components)) regardless of whether all the constituent elements are contained in the same casing. Accordingly, a plurality of devices accommodated in separate casings and connected via a network and one device in which a plurality of modules are accommodated in one casing are all systems.

For example, a configuration described as one device (or processing unit) may be divided and configured as a plurality of devices (or processing units). On the other hand, the configuration described above as a plurality of devices (or processing units) may be collectively configured as one device (or processing unit). Further, of course, a configuration other than the above may be added to the configuration of each device (or each processing unit). Further, a part of the configuration of a device (or processing unit) may be included in the configuration of another device (or another processing unit) as long as the configuration or operation of the system as a whole is substantially the same.

Note that embodiments of the present technology are not limited to the above-mentioned embodiments and can be modified in various manners without departing from the scope and spirit of the present technology. The advantageous effects described herein are merely exemplary and are not limited, and other advantageous effects of the advantageous effects described in the present specification may be achieved.

The present technology can be configured as follows.

(1)

A server device including a broker that filters each of first object data that is object data of a first object and second object data that is object data of a second object based on a determined filter condition, the first object and the second object being to be displayed in a virtual space, and sends the filtered object data to a rendering server.

(2)

The server device according to (1), wherein
the first object data is object data generated based on sensor data acquired by a client device at a first place where a first subject is present, and
the second object data is object data generated based on sensor data acquired by a client device at a second place where a second subject is present, the second place being different from the first place.

(3)

The server device according to (1) or (2), wherein the broker includes
a determination unit that negotiates with a server corresponding to a client device for a viewer who views the first object and the second object and that determines the filter condition, and
a filter that filters the object data based on the determined filter condition.

(4)

The server device according to (3), wherein the determination unit and the filter are deployed on a cloud different from the rendering server.

(5)

The server device according to (3), wherein
the determining unit is deployed on a cloud different from the rendering server, and
the filter is deployed on the same cloud as the rendering server.

(6)

The server device according to any one of (1) to (5), wherein the filter condition includes a filter condition related to a scope of a viewer who views the first object and the second object.

(7)

The server device according to any one of (1) to (6), wherein the filter condition includes a filter condition related to a distance to a target object in the virtual space.

(8)

The server device according to any one of (1) to (7), wherein the filter condition includes a filter condition related to movement of a target object.

(9)

The server device according to any one of (1) to (8), wherein the filter condition includes a filter condition related to a brightness or color of a target object, or a volume of a voice uttered by the target object.

(10)

The server device according to any one of (1) to (9), wherein the filter condition includes a filter condition related to an action of a target object or a phrase spoken by the target object.

(11)

The server device according to any one of (1) to (10), wherein the filter condition includes a filter condition related to a degree of interest in a target object.

(12)

The server device according to any one of (1) to (11), wherein the filter condition includes a filter condition depending on physical environmental factors with respect to a target object.

(13)

The server device according to any one of (1) to (12), wherein an object data server that generates the object data and the rendering server are configured to have a relationship of n:m.

(14)

The server device according to any one of (1) to (13), wherein based on a status of load of a cloud or a status of traffic between a client device that displays an image based on the object data and the cloud, whether the rendering server is deployed on the cloud or in the client device is selected.

(15)

The server device according to (14), wherein whether the rendering server is deployed on the cloud or in the client device is selected depending on type of the object data.

(16)

The server device according to any one of (1) to (15), wherein the rendering server is shared by a plurality of client devices that display an image based on the object data.

(17)

The server device according to (16), wherein whether the rendering server is shared by the plurality of client devices is selected depending on type of the object data.

(18)

A network control method including: by a server device,
filtering each of first object data that is object data of a first object and second object data that is object data of a second object based on a determined filtering condition, the first object and the second object being to be displayed in a virtual space; and sending the filtered object data to a rendering server.

### REFERENCE SIGNS LIST

1 Data processing system
11AJ Adjacent audience
11AR Artist
11AU Audience
11ME Viewer
11NJ Nonadjacent audience
12 Concert venue
20 Client device
21 Sensor
22 Display
23 Client side renderer
30 Server device
31 Object data server
32 Object data publisher
33 Object data subscriber
34 Server side renderer
35 Edge resource orchestrator
40 Server device
41 Live entertainment broker
41L Local live entertainment broker
42 Virtual space DB
43 Object metadata DB
51 Subscription manager
52 Filter
101 Filter data
111 Filter condition
112 Weighting parameter
113 Weighting parameter formula
301 Data sensor
302 Render data display
303 Object data renderer
311 Object data renderer
321 Object data generator
322 Object data server
331 Object data extractor
332 Object data publisher
341 Object data change detector
342 Object data subscriber
343 Object data forwarder
351 Renderer life cycle manager
352 Renderer aggregation manager
800 Network system
805 Computer
810 Network
815 Remote computer
820 Web server
825 Cloud storage server
830 Computer server
835 Processor
840 Memory
845 Non-volatile storage
848 Program
850 Network interface
870 Display

1. A server device comprising: a broker that filters each of first object data that is object data of a first object and second object data that is object data of a second object based on a determined filter condition, the first object and the second object being to be displayed in a virtual space, and sends the filtered object data to a rendering server.

2. The server device according to claim 1, wherein
the first object data is object data generated based on sensor data acquired by a client device at a first place where a first subject is present, and
the second object data is object data generated based on sensor data acquired by a client device at a second place where a second subject is present, the second place being different from the first place.

3. The server device according to claim 1, wherein the broker includes
a determination unit that negotiates with a server corresponding to a client device for a viewer who views the first object and the second object and that determines the filter condition, and
a filter that filters the object data based on the determined filter condition.

4. The server device according to claim 3, wherein the determination unit and the filter are deployed on a cloud different from the rendering server.

5. The server device according to claim 3, wherein
the determining unit is deployed on a cloud different from the rendering server, and
the filter is deployed on the same cloud as the rendering server.

6. The server device according to claim 1, wherein the filter condition includes a filter condition related to a scope of a viewer who views the first object and the second object.

7. The server device according to claim 1, wherein the filter condition includes a filter condition related to a distance to a target object in the virtual space.

8. The server device according to claim 1, wherein the filter condition includes a filter condition related to movement of a target object.

9. The server device according to claim 1, wherein the filter condition includes a filter condition related to a brightness or color of a target object, or a volume of a voice uttered by the target object.

10. The server device according to claim 1, wherein the filter condition includes a filter condition related to an action of a target object or a phrase spoken by the target object.

11. The server device according to claim 1, wherein the filter condition includes a filter condition related to a degree of interest in a target object.

12. The server device according to claim 1, wherein the filter condition includes a filter condition depending on physical environmental factors with respect to a target object.

13. The server device according to claim 1, wherein an object data server that generates the object data and the rendering server are configured to have a relationship of n:m.

14. The server device according to claim 1, wherein based on a status of load of a cloud or a status of traffic between a client device that displays an image based on the object data and the cloud, whether the rendering server is deployed on the cloud or in the client device is selected.

15. The server device according to claim 14, wherein whether the rendering server is deployed on the cloud or in the client device is selected depending on type of the object data.

16. The server device according to claim 1, wherein the rendering server is shared by a plurality of client devices that display an image based on the object data.

17. The server device according to claim 16, wherein whether the rendering server is shared by the plurality of client devices is selected depending on type of the object data.

18. A network control method comprising: by a sever device,
filtering each of first object data that is object data of a first object and second object data that is object data of a second object based on a determined filtering condition, the first object and the second object being to be displayed in a virtual space; and sending the filtered object data to a rendering server.
